(19) United States
(12) Patent Application Publication
(10) Pub. No.: US 2026/0031862 A1
(43) Pub. Date: Jan. 29, 2026

(54) RECONFIGURABLE INTELLIGENT SURFACE DEFORMATION MITIGATION

(71) Applicant: Qualcomm Incorporated, San Diego, CA (US)

(72) Inventors: Narayan PRASAD, Westfield, NJ (US); Kobi RAVID, Closter, NJ (US); Tao LUO, San Diego, CA (US); Peter GAAL, San Diego, CA (US); Junyi LI, Greentown, PA (US)

(21) Appl. No.: 18/787,815

(22) Filed: Jul. 29, 2024

(51) Int. Cl. H04B 7/04; H04B 7/0456

(52) U.S. Cl. CPC H04B 7/04026; H04B 7/0456

(57) ABSTRACT

Certain aspects of the present disclosure provide techniques for reconfigurable intelligent surface (RIS) deformation mitigation. A method generally includes configuring a plurality of nodes with a plurality of resources for communicating a plurality of signals with the apparatus or a network entity via a RIS comprising a plurality of RIS elements; obtaining observation information associated with the plurality of signals communicated between the plurality of nodes and the apparatus or the network entity via the RIS; determining an RIS element deformation for at least one RIS element based on the observation information and a deformation database associated with the RIS, the deformation database providing a mapping between a plurality of RIS element deformations and one or more observations expected for each of the plurality of RIS element deformations; and sending a codebook pattern update to compensate for the RIS element deformation for the at least one RIS element.

### INTRODUCTION

### Field of the Disclosure

Aspects of the present disclosure relate to wireless communications, and more particularly, to techniques for reconfigurable intelligent surface deformation mitigation.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes configuring a plurality of nodes with a plurality of time-frequency resources for communicating a plurality of signals with the apparatus or a network entity via a reconfigurable intelligent surface (RIS) comprising a plurality of RIS elements; obtaining observation information associated with the plurality of signals communicated between the plurality of nodes and the apparatus or the network entity via the RIS; determining an RIS element deformation for at least one RIS element of the plurality of RIS elements based at least in part on the observation information and a deformation database associated with the RIS, the deformation database providing a mapping between a plurality of RIS element deformations and one or more observations expected for each of the plurality of RIS element deformations; and sending, to at least one of the RIS or the network entity, a codebook pattern update to compensate for the RIS element deformation for the at least one RIS element.

Another aspect provides a method for wireless communications by an apparatus. The method includes receiving a first configuration of a plurality of time-frequency resources for receiving a plurality of signals via a RIS comprising a plurality of RIS elements; receiving, via one or more of the plurality of time-frequency resources, one or more signals of the plurality of signals via the RIS; determining observation information associated with the one or more signals received at the apparatus, wherein the observation information comprises at least one of: one or more in-phase and quadrature (IQ) samples; one or more reference signal received power (RSRP) measurements; or one or more phase estimations; and sending the observation information to a first network entity.

Another aspect provides a method for wireless communications by an apparatus. The method includes sending, to a RIS comprising a plurality of RIS elements, a first request to obtain first deformation information from a subset of a plurality of sensors of the RIS, wherein the first deformation information is associated with a subset of the plurality of RIS elements; receiving the first deformation information; and estimating an RIS element deformation for at least one RIS element of the subset of the plurality of RIS elements based at least in part on the first deformation information.

Another aspect provides a method for wireless communications by an apparatus. The method includes receiving a first request to obtain first deformation information from a subset of a plurality of sensors of the apparatus, wherein: the apparatus comprises a plurality of RIS elements configured to modify signals between nodes, and the first deformation information is associated with a subset of the plurality of RIS elements; and based at least in part on receiving the first request: obtaining the first deformation information from the subset of the plurality of sensors and sending the first deformation information.

Another aspect provides a method for wireless communications by an apparatus. The method includes sending, to a node comprising one or more image sensors, a first request to obtain one or more first images of a subset of a plurality of RIS elements of a RIS via the one or more image sensors; receiving the one or more first images based at least in part on sending the first request; and estimating an RIS element deformation for at least one RIS element of the subset of the plurality of RIS elements based at least in part on the one or more first images.

Another aspect provides a method for wireless communications by an apparatus. The method includes receiving a first request to obtain one or more first images of a subset of a plurality of RIS elements of a RIS via one or more image sensors of the apparatus; and based at least in part on receiving the first request: obtaining the one or more first images and sending the one or more first images.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example arrangement of reconfigurable intelligent surface elements.

FIG. 6A depicts an example of communication blockage between wireless communication devices.

FIG. 6B depicts an example of using a reconfigurable intelligent surface to overcome communication blockage between wireless communication devices.

FIG. 7 depicts example phase errors resulting from reconfigurable intelligent surface element deformation.

FIG. 8A depicts a process flow for communications in a network between a network entity, a base station, multiple user equipments, and a reconfigurable intelligent surface controller to enable mitigation of reconfigurable intelligent surface deformation.

FIG. 8B depicts another process flow for communications in a network between a network entity, a base station, and multiple user equipments, and a reconfigurable intelligent surface controller to enable mitigation of reconfigurable intelligent surface deformation.

FIG. 9 depicts example reconfigurable intelligent surface-assisted communication performance gain using reconfigurable intelligent surface deformation mitigation techniques described herein.

FIG. 10 depicts a process flow for communications in a network between a network entity, a base station, and a reconfiguration intelligent surface controller to enable mitigation of reconfigurable intelligent surface deformation.

FIG. 11 depicts another process flow for communications in a network between a network entity, a base station, and a reconfiguration intelligent surface controller to enable mitigation of reconfigurable intelligent surface deformation.

FIG. 12 depicts a method for wireless communications.

FIG. 13 depicts another method for wireless communications.

FIG. 14 depicts another method for wireless communications.

FIG. 15 depicts another method for wireless communications.

FIG. 16 depicts another method for wireless communications.

FIG. 17 depicts another method for wireless communications.

FIG. 18 depicts aspects of an example communications device.

FIG. 19 depicts aspects of another example communications device.

FIG. 20 depicts aspects of an example communications device.

### DETAILED DESCRIPTION

Aspects of the present disclosure provide apparatuses, methods, processing systems, and computer-readable mediums for reconfigurable intelligent surface (RIS) deformation mitigation.

A RIS (also commonly referred to as an “intelligent reconfigurable surface”, a “reflecting intelligent surface”, a “reconfigurable impedance surface,” an “intelligent reflection surface,” and/or an “intelligent reconfigurable surface”) is a technology that has the ability to cost-effectively improve the performance of wireless networks. For example, a RIS is a surface of electromagnetic (EM) material used to intentionally control the propagation of electromagnetic waves, such as radio signals, in wireless communication systems. A RIS may consist of an array of multiple small, low cost, configurable/reconfigurable elements (referred to herein as “RIS elements”). Different configurations for the RIS elements may allow a RIS to modify the way that radio signals are reflected, refracted, and/or absorbed. For example, one example RIS may include an array of reflecting RIS elements that are dynamically (re) configured to control the modification of radio signals. Another example RIS may include an array of RIS elements that are dynamically (re) configured to redirect and pass through incident radiation. RIS elements may be able to tune the amplitudes and/or phase shifts of incident radio signals in real time, thereby enabling dynamic control over a wireless signal propagation environment.

In some cases, a RIS may be used to redirect and/or amplify (e.g., using an amplifier) radio signals to thereby improve signal strength in areas where the signal strength is weak or nonexistent. For example, the RIS may be used to improve the coverage and increase the capacity of cellular networks (e.g., which may be especially beneficial in rural areas and/or in areas with a larger number of user devices). In some cases, a RIS may include an amplifier for reflection amplification to effectively reduce path loss (e.g., the loss or attenuation a propagating radio signal encounters along its path from transmitter to receiver), and thus improve the reliability of wireless communications. In some cases, a RIS may be used to help eliminate “blind spots” caused by communication blockages (e.g., blind spots refer to areas that have neither direct nor indirect line of sight (LoS) links to any network entity). For example, in cases where a non-LoS (NLoS) link exists between a transmitter and receiver, a direct path between the transmitter and receiver may include one or more physical obstructions (e.g., such as buildings, trees, mountains, etc.). Thus, radio signals sent to the receiver may be weakened when reaching the receiver, thereby reducing the quality of communications between the transmitter and the receiver. To bypass the blockage, a RIS may be used to modify (or shape) (e.g., which is used herein to encompass re-radiating, reflecting, refracting, scattering, re-directing, etc. by the RIS) the radio signal towards the receiver. By steering the impinging signal towards the receiver, the RIS creates an alternative path for communications between the transmitter and the receiver, thereby improving the quality of the communication between the transmitter and the receiver.

A technical challenge of deploying RISs involves their susceptibility to deformation. RIS deformation may include changes in location and/or orientation of individual RIS element(s), or group(s) of RIS elements, of the RIS. A location deformation may include a translation of a RIS element, or a group of RIS elements, about a fixed reference point whose coordinates are globally fixed (e.g., globally fixed after first deploying of the RIS). Thus, one location deformation may include a translation of a RIS element, or a group of RIS elements, to a location on a surface of the RIS different from an intended location (e.g., an intended location determined during design and/or manufacturing) of the RIS element, or the group of RIS elements, on the surface of the RIS (e.g., with respect to the fixed reference point). The location deformation may include left movement, right movement, movements towards the top of the RIS, movement towards the bottom of the RIS, movement towards the sides of the RIS, movement towards the center of the RIS, etc. Another location deformation may include a translation of a RIS element, or a group of RIS elements, with respect to the fixed reference point based at least in part on the expansion or contraction of the RIS (e.g., such as due to external factors, including changes in temperature). With this location deformation, a location of the RIS element or group of RIS elements with respect to the RIS itself may remain in the same location, while the global coordinates of the RIS element/group of RIS elements change.

An orientation deformation may include a change in a pointing direction of a normal vector of a RIS element or a normal vector associated with a group of RIS elements. For example, an example orientation deformation may include the rotation of a RIS element, or a group of RIS elements, to an orientation different from an intended orientation (e.g., an intended orientation associated with the normal vector and determined during design, manufacturing, and/or via a controller of the RIS) of the RIS element, or the group of RIS elements. The orientation deformation may include titling forward, tilting backwards, tilting left, tilting right, rotating left, rotating right, etc.

In certain aspects, a RIS element or a group of RIS elements may experience both a location deformation and an orientation deformation. For example, a RIS element, or a group of RIS elements, may be subject to bend-type deformations (e.g., convex bending, concave bending, etc.). Bend-type deformations may be described as a combination of location and orientation deformations.

A RIS may suffer from deformation(s) emanating from manufacturing and/or deployment of the RIS, as well as, in some cases, from the overall design of the RIS. As an illustrative example, higher manufacturing tolerances (e.g., greater range of allowable variation in a RIS' size, RIS element position, and/or other physical properties of the RIS) may be accepted during manufacturing of the RIS to control the cost of the RIS (e.g., a RIS may be more beneficial for deployment than a network node, an integrated access and backhaul (IAB) node, and/or the like). In general, devices with higher manufacturing tolerances are less expensive to manufacture than devices with lower tolerances. Accordingly, to achieve manufacturing at a low cost, minor defects in RIS size, RIS element location and/or orientation, and/or other physical properties of the RIS may be allowed. As another illustrative example, to keep costs low, a RIS may be manufactured from a cheaper material that is more prone to deformation when subjected to environmental factors, such as heating, cooling, solar radiation, wind, rain, etc. Thus, when the RIS is deployed for use in a wireless communications environment (e.g., such as deployed on a billboard), external force(s) (e.g., such as wind) may cause the RIS to bend or deform (which in turn may affect the location and/or orientation of RIS element(s) of the RIS).

RIS deformation inevitably degrades RIS performance and thus limits the full potential of a RIS deployed in a wireless signal propagation environment. For example, a particular beamformer weight (e.g., a particular beamforming or precoding weight) may be selected for and applied to each RIS element of the RIS to cause the RIS to modify a radio signal with a particular phase shift. Even small deformation (e.g., a slight change in expected location and/or orientation) of a RIS element may significantly alter the phase shift provided by the RIS element. As such, a radio signal modified (e.g., reflected, refracted, etc.) by the RIS element towards a receiver may cause the radio signal to be received at the receiver with a lower signal quality than expected. Put differently deformation(s) of one or more RIS elements of a RIS may cause the RIS to behave not as it was intended to, which may degrade RIS performance at least with respect to improving wireless communication performance in a wireless signal propagation environment. Further, the impact of bend-type deformation on a RIS element or a group of RIS elements may be more severe given this type of deformation may induce correlated phase shift offsets which degrade RIS performance more.

Certain aspects described herein overcome the aforementioned technical problems associated with RIS use and deployment and provide a technical benefit to the field of telecommunications. For example, aspects described herein provide techniques for RIS deformation mitigation when deployed in a wireless communications environment (e.g., while in use in the field). As described herein, RIS deformation mitigation may include estimating the deformation for at least one RIS element of a previously-deployed RIS and determining a codebook update for at least the one RIS element to compensate for the estimated deformation of the RIS element. In certain aspects, the deformation is ascertained for multiple RIS elements of the RIS, such that a codebook update includes updates to precoding weights for the multiple RIS elements.

As described herein, various methods may be used to perform RIS deformation mitigation for a RIS previously deployed to control radio signal propagation. The deformation mitigation may be performed in response to identifying that performance of the RIS is not as expected and thus may be degraded. The degradation may be due to at least a deformation of one or more RIS elements of the RIS.

In a first illustrative method, after identifying that RIS performance is degraded for a previously-deployed RIS, multiple nodes (e.g., such as user equipments (UEs)) may be configured in the wireless communications environment that includes the RIS. The nodes may be configured to communicate radio signals with a first network entity using the degraded RIS. For example, in certain aspects, the nodes may receive, from the first network entity, the radio signals via the RIS (e.g., via reflection), obtain observation information associated with the radio signals, and provide this observation information to the first network entity or a second network entity. In certain aspects, the network entity may receive, from the nodes, the radio signals via the RIS (e.g., via reflection), obtain observation information associated with the radio signals, and, optionally in some cases, provide this observation information to the second network entity. The observation information may be information that is configured to be used for adjusting a codebook pattern (e.g., precoding weights applied to RIS element(s)) of the RIS. As such, the first network entity or the second network entity (after receiving the observation information) may use the observation information to estimate a RIS element deformation for at least one RIS element of the RIS. In certain aspects, the first network entity or the second network entity estimates the deformation based on a deformation database including correlations between different observations expected for different RIS element deformations. The estimated deformation(s) may then be used to adjust one or more precoding weights applied to one or more RIS elements of the RIS to compensate for the degradation in performance due to RIS element deformation.

In a second illustrative method, sensor information may be used to estimate RIS element deformation, which may then be used to update a codebook such that RIS-assistance performance is improved even when one or more of the RIS' elements are deformed. For example, one or more sensors may be deployed (e.g., installed) on a surface of a previously-deployed RIS. The sensor(s) may be configured to obtain deformation information for one or more RIS elements on the RIS. Accordingly, in some cases after identifying that RIS performance is degraded for a previously-deployed RIS, a network entity may send a request, to the RIS, to obtain, from one or more of the sensor(s) of the RIS, deformation information for one or more of the RIS elements. In response to receiving this request, the RIS may send the requested deformation information to the network entity, which may then be used by the network entity to estimate a RIS element deformation for at least one RIS element of the RIS. The estimated deformation(s) may then be used to adjust one or more precoding weights applied to one or more RIS elements of the RIS to compensate for the degradation in performance due to RIS element deformation.

In a third illustrative method, image(s) of RIS element(s) may be used to estimate deformation for these element(s), which may then be used to update a codebook such that RIS-assistance performance is improved even when one or more of the RIS' elements are deformed. For example, image(s) of RIS element(s) of the RIS may be provided to a network entity. The network entity may use the image(s) to estimate a RIS element deformation for at least one RIS element of the RIS. The estimated deformation(s) may then be used to adjust one or more precoding weights applied to one or more RIS elements of the RIS to compensate for the degradation in performance due to RIS element deformation.

Certain techniques for RIS deformation mitigation described herein may provide various beneficial technical effects and/or advantages. For example, the techniques for RIS deformation mitigation may enable the wireless communications network to realize the full benefits offered by RIS-assisted communication, such as improved wireless coverage and increased capacity, at a fraction of the cost of deploying other node(s) in the network to perform similar functions. The ability to realize the benefits of RIS-assisted communication may be attributable to one or more of the RIS deformation methods used, and described above, given such methods help to improve and/or maintain optimal RIS performance even when the RIS includes one or more deformed RIS elements. The RIS performance is improved and/or maintained by updating a codebook to account for any RIS element deformation present for one or more RIS elements of the RIS.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

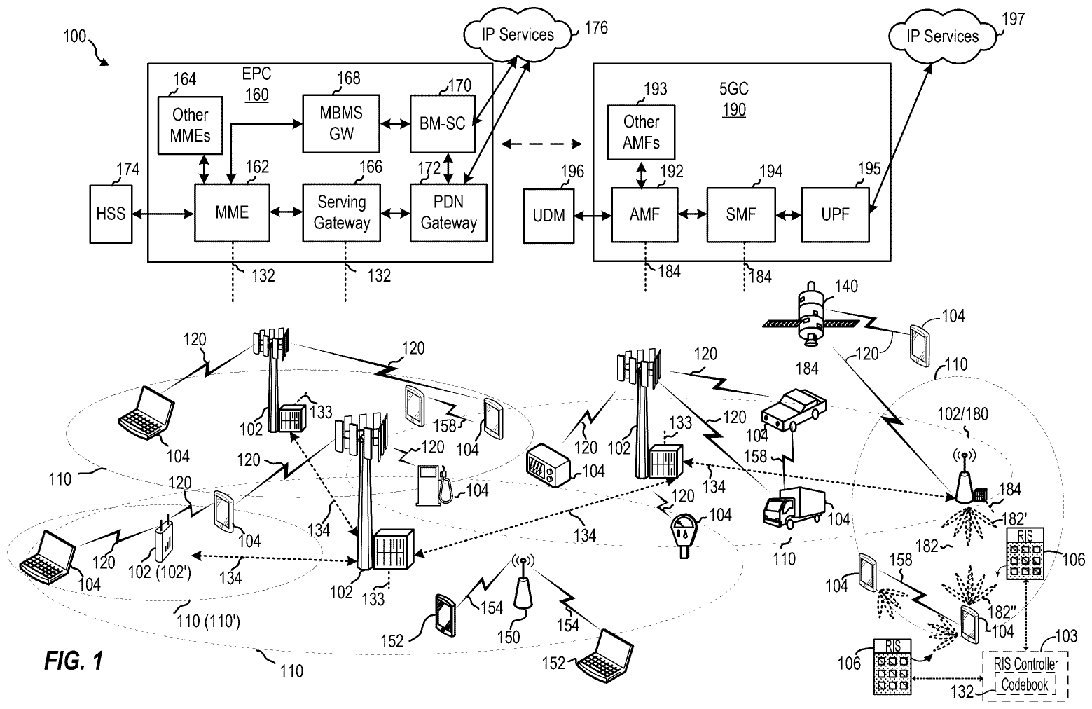

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

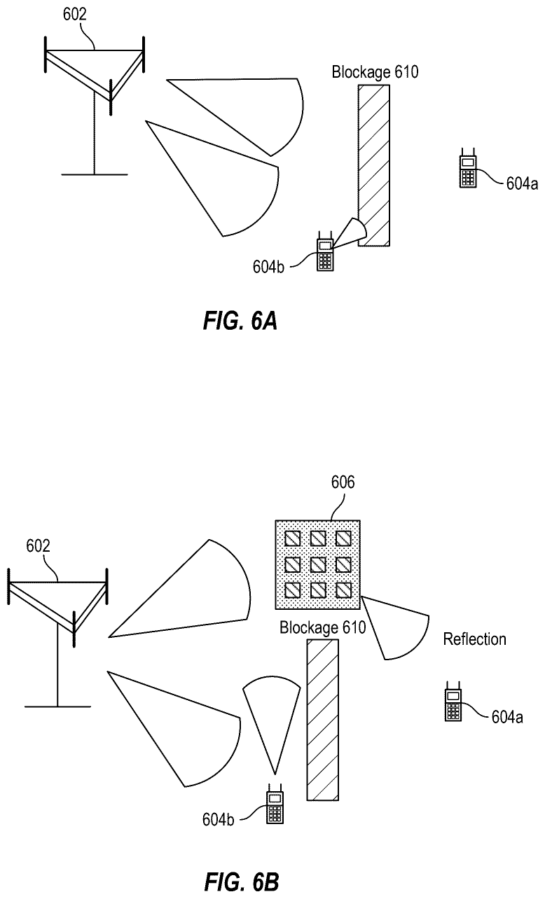

In certain aspects, a RIS 106 may assist communication between a BS 102 and a UE 104. For example, RIS 106 assistance may be useful when communication between BS 102 and UE 104 is blocked by one or more obstacles (e.g., also referred to herein as “blockages,” such as buildings, etc., which are shown as blockage 610 in in FIGS. 6A and 6B). RIS 106 may enable communications between BS 102 and UE 104 to be received and modified, thereby avoiding the obstacles. For example, RIS 106 may be configured with a codebook for precoding one or more elements thereon (referred to as “RIS elements”) to allow a beam from one of BS 102 or UE 104 (e.g., a transmitter) to be modified (e.g., reflected off RIS 106) to reach the other one of BS 102 or UE 104 (e.g., a receiver). The direction (e.g., phase) and/or amplitude of the modified beam by RIS 106 may be controlled or reconfigured by RIS controller 103 of RIS 106.

For example, RIS controller 103 includes a codebook 132 for applying a beamformer weight (e.g., a precoding weight, such as a multiplier or offset of time delay) to RIS elements of RIS 106. Codebook 132 includes values of precoding weights to configure each RIS element (or one or more groups of RIS elements) to modify a radio signal by RIS 106. RIS controller 103 may configure (or reconfigure) each RIS element (or one or more groups of RIS elements) such that each RIS element (or group) is able to tune the amplitude and/or phase shift of an incident radio signal. Put differently, configuring each RIS element by applying a beamformer weight (e.g., a precoding weight) to each RIS element may enable RIS 106 to modify an output beam at different directions (and/or amplitudes) given a particular input beam.

In an example, UE 104 may be a transmitter communicating with BS 102 (e.g., a receiver) over a wireless Uu interface. BS 102 may provide RIS controller 103 feedback for selecting beamformer values (e.g., precoding weights) for the RIS elements to enhance signal quality of a radio signal received at BS 102 from UE 104 (e.g., when modified using RIS 106). Similarly, when a first UE 104-1 establishes a sidelink (e.g., PC5 interface) with a second UE 104-2, first UE 104-1 may be the transmitter and second UE 104-2 may be the receiver. Accordingly, second UE 104-2 may provide RIS controller 103 with feedback for selecting beamformer values for the RIS elements.

Codebook 132 may be generated based on specific settings of BS 102 and UE 104, and based on different parameters specific to different situations. The feedback from a receiver to RIS controller 103 may allow for the selection of beamformer values for assisting communications between a transmitter and the receiver. Other configurations in wireless communication network 100 may be similarly setup between UEs 104 and BSs 102.

In certain aspects, RIS controller 103 comprises a mechanism to receive indication(s) of codeword(s) (e.g., a codeword is a set of precoding weights for the RIS elements) via a control link and apply the indicated codeword(s). In certain aspects, RIS controller 103 may include a field programmable gate array (FGPA) board, which may be programmable to enable RIS controller 103 to receive the indication(s) of the codeword(s) via the control link and generate corresponding control signal(s). In certain aspects, RIS controller 103 may include control drive circuit(s) (e.g., such as shift register(s) and/or digital-to-analog convertor(s) with operational-amplifier(s)) configured to drive a set of current/voltage lines connected to tunable electronic components (e.g., such as positive-intrinsic-negative (PIN) and/or varactor diodes) on the RIS elements. By changing the tunable electronic components on the RIS elements, the electromagnetic properties (e.g., such as scattering) of those associated RIS elements may be changed.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

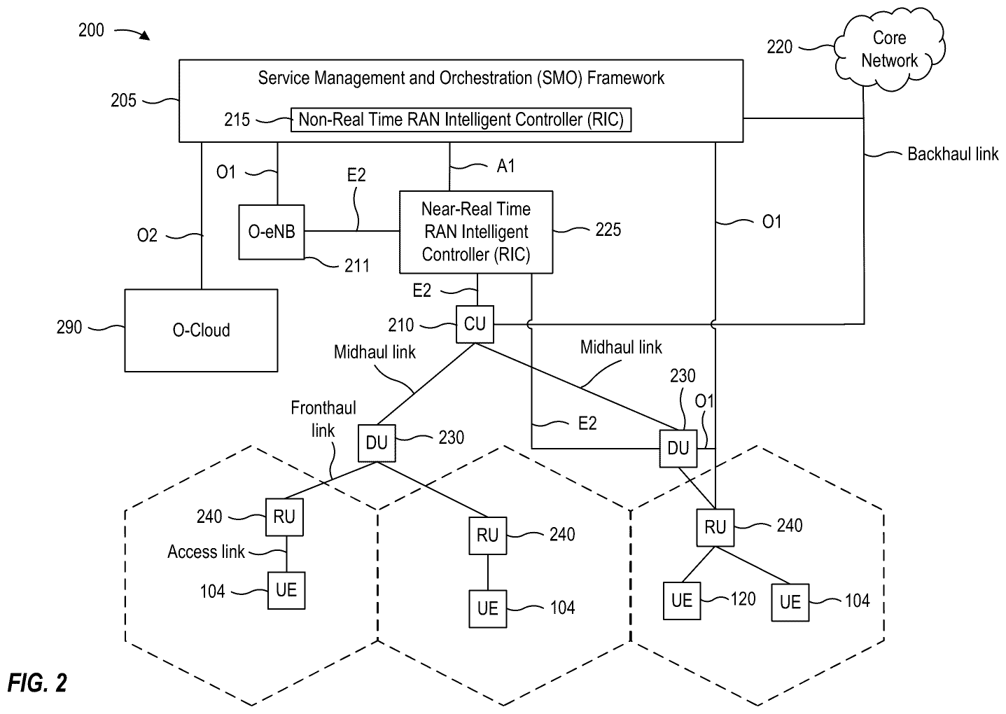

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 133 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHZ-71,000 MHZ, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

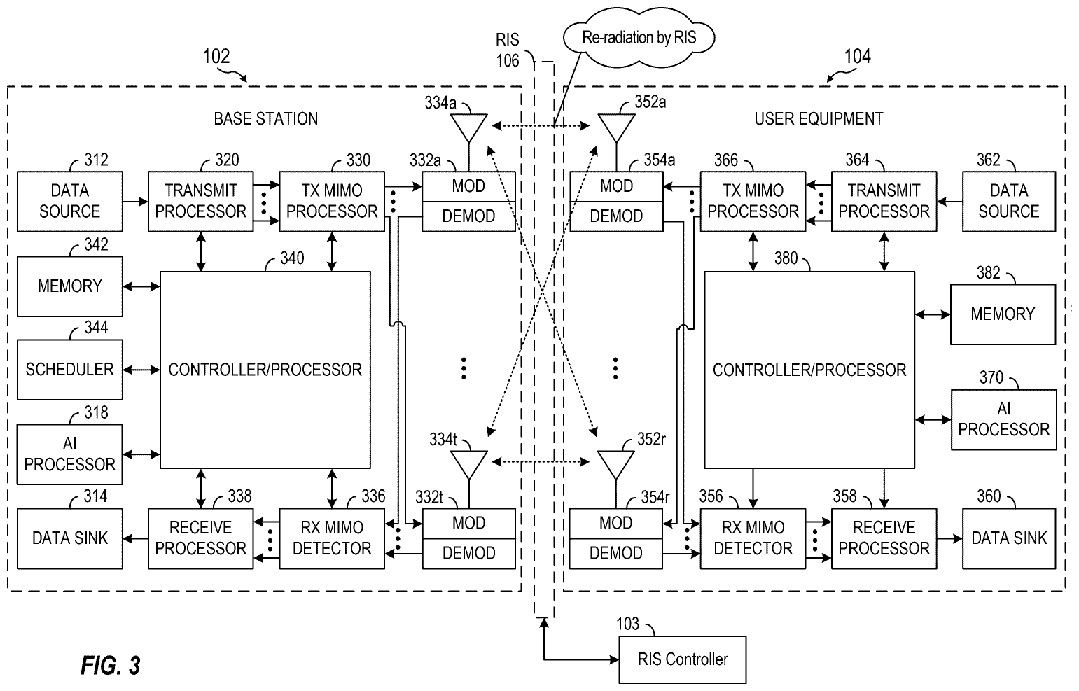

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

A RIS 106 may be used to receive and modify radio signals when communications between BS 102 and UE 104 are impeded and/or blocked by obstacles (not shown in FIG. 3, but illustrated as the blockage 610 in FIGS. 6A and 6B). For example, RIS 106 may modify the transmission(s) from one of BS 102 or UE 104 to the other using reflection, refraction, and/or other passive and/or active mechanisms.

In certain aspects, RIS 106 may be configured/reconfigured and/or controlled by a RIS controller 103. For example, RIS controller 103 may configure each RIS element (or group of RIS elements) by applying a precoding weight to each RIS element (or group of RIS elements), such that each RIS element (or group of RIS elements) modifies radio signals with a certain phase and/or amplitude.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

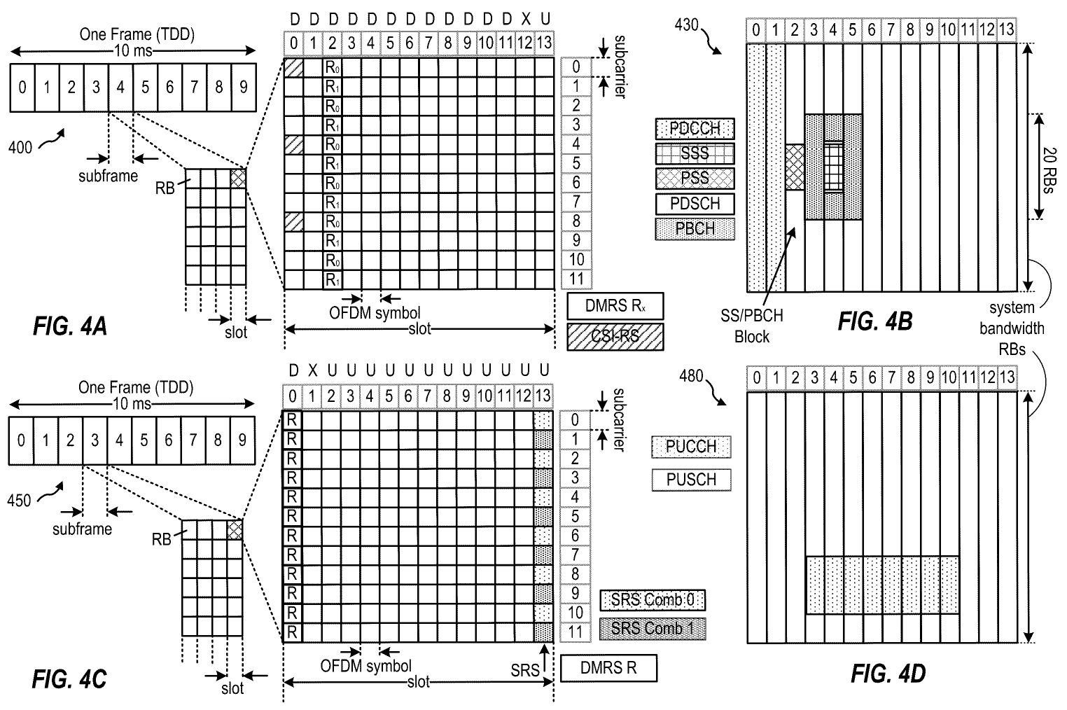

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Aspects Related to RISs

As described herein, in a wireless communications network (e.g., such as wireless communications network 100 depicted and described with respect to FIG. 1), a RIS (e.g., such as RIS 106 of FIGS. 1 and 3) may be deployed and configured to control the modification (e.g., reflection, refraction, scattering, re-radiation, re-direction, etc.) of electromagnetic waves (e.g., radio signals) between nodes (e.g., such as UE(s) 104 of FIGS. 1 and 3, BS(s) 102 of FIGS. 1 and 3, and/or a disaggregated base station as discussed with respect to FIG. 2). RISs can be deployed on several structures, including but not limited to building facades, indoor walls, aerial platforms, billboards, vehicle windows, and the like.

A RIS may include RIS elements. The RIS elements may be arranged in any suitable arrangement on the array (e.g., uniformly distributed or non-uniformly distributed). Further, the RIS elements may take on uniform or non-uniform geometries.

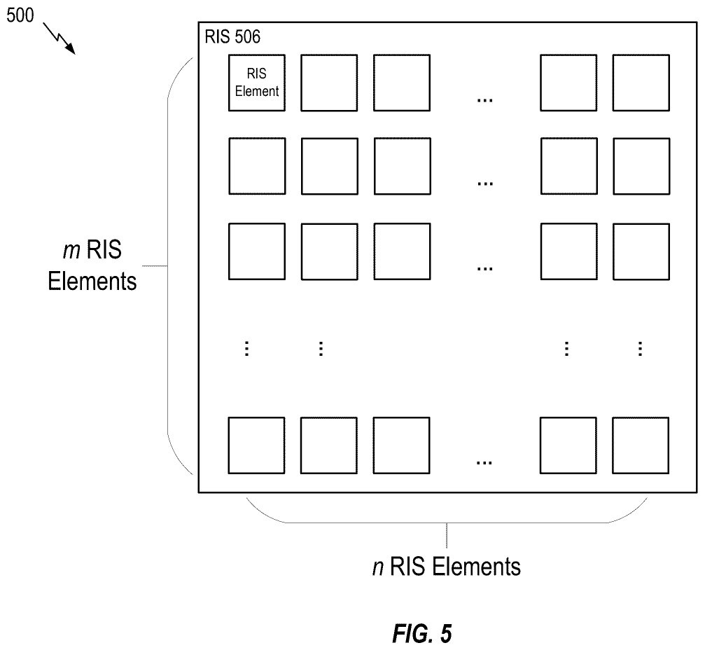

FIG. 5 depicts an example arrangement 500 of RIS elements (e.g., such as RIS elements of RIS 106 in FIGS. 1 and 3). As illustrated in FIG. 5, the surface of RIS 506 consists of an array of discrete, RIS elements, such as an m×n rectangular matrix of discrete RIS elements, that may be controlled individually or at a group level. Such RIS elements may enable RIS 506 to perform passive beamforming. For example, RIS 506 may receive signal power from a transmitter (e.g., BS, UE, etc.) proportional to the number of RIS elements thereon. When RIS 506 modifies the radio signal, RIS elements of RIS 506 may cause phase shifts to perform beamforming. The phase shifts may be controlled by beamformer weights (e.g., precoding weights) applied to the RIS elements of RIS 106. In some cases, for the array of RIS elements illustrated in FIG. 5, for example, a respective beamformer weight may be generated or specified for each of the RIS elements by a RIS controller associated with RIS 506 (e.g., such as RIS controller 103 of FIGS. 1 and 3).

RIS elements may be composed of any suitable materials that may modify an incident radio signal waveform. For example, a RIS may modify an incident radio signal waveform in a controlled manner to enhance or improve channel diversities. Increasing channel diversities may provide robustness to channel blocking and/or fading (e.g., fading is a phenomenon in which the strength and quality of a radio signal fluctuates due to varying parameters and conditions of the channel during wireless propagation), which may be particularly useful for millimeter wave (mmWave) communications and other high-frequency communications.

For example, a RIS may be particularly effective at mmWave and sub-THz frequencies given the relative lack of signal diffraction and susceptibility to blockage and/or attenuation at these frequencies. Specifically, RISs are capable of reconfiguring the wireless propagation environment by compensating for the power loss over long distances. RISs deployed in the environment may form virtual LOS links between a transmitter and a receiver (e.g., BS(s) and/or UE by passively modifying the impinging radio signals to be directed towards the receiver. Further, RISs are capable of reconfiguring the wireless propagation environment by providing alternative routes for radio signals between a transmitter and a receiver. For example, RISs may be used to modify radio signals between a transmitter and a receiver in order to bypass blockages that exist in a direct path between the transmitter and the receiver. As such, RISs may help to increase wireless coverage and spectral capacity, thereby improving overall wireless communications performance.

The use of a RIS to overcome blockage and to improve communications between a transmitter and a receiver is depicted in FIGS. 6A-6B. In particular, FIG. 6A depicts an example of blockage 610 between a network entity 602 (e.g., a transmitter) and a first UE 604a. FIG. 6B depicts an example of using a RIS 606 to overcome the blockage 610. In certain aspects, the network entity 602 may be an example of the BS 102 depicted and described with respect to FIGS. 1 and 3 or a disaggregated base station depicted and described with respect to FIG. 2. Similarly, the first UE 604a may be an example of UE 104 depicted and described with respect to FIGS. 1 and 3. However, in other aspects, first UE 604a may be another type of wireless communications device and network entity 602 may be another type of network entity or network node, such as those described herein. In certain aspects, the RIS 606 may be an example of the RIS 106 102 depicted and described with respect to FIGS. 1 and 3.

As shown in FIG. 6A, while network entity 602 may be able to communicate with (e.g., send radio signal(s) to) a second UE 604b, blockage 610 may prevent radio signals, sent to first UE 604a, from reaching first UE 604a. Put differently, blockage 610 may impede communications sent from network entity 602 to first UE 604a. Further, as shown, blockage 610 may also prevent second UE 604 (b) from establishing sidelink communications with first UE 604a.

As shown in FIG. 6B, to overcome the blockage, a RIS 606 may be deployed to modify radio signals to first UE 604a. In other words, RIS 606 may be deployed to assist communications in bypassing blockage 610. For example, in some cases, two-way communications between network entity 602 and first UE 604a may be enabled by RIS 606 modifying one or more radio signals (e.g., via one or more beams) from network entity 602 towards first UE 604a, and vice versa. Furthermore, in some cases, RIS element(s) of RIS 606 may be reconfigured, such as with different beamformer value(s) (e.g., precoding weight(s)), to enable first UE 604a and second UE 604b to establish sidelink communications.

Thus, as shown in FIG. 6B, use of RIS 606 can significantly improve the quality of signal transmission, especially in NLOS communication scenarios.

Further, in contrast to conventional relaying systems (e.g., amplify-and-forward (AF) and decode-and-forward (DF)), RISs may be capable of modifying an incoming radio signal by controlling the phase shift of each RIS element instead of employing a power amplifier, which beneficially significantly reduces power consumption. Thus, deploying RISs is more energy-efficient than conventional relaying systems.

Thus, as described above, RISs may offer an energy-efficient, low-cost deployment solution for improving wireless communications, including enhancing coverage performance in wireless communications networks by intentionally modify radio signals to control the propagation of radio signals to and from network nodes.

### Example Aspects Related to RIS Deformation

While a RIS has the ability to provide the aforementioned benefits, RIS-assisted communications may be degraded when one or more RIS elements of the RIS are deformed. As described above, RIS element(s) may become deformed during manufacturing of the RIS and/or after deployment of the RIS to assist in wireless communications between nodes.

For example, deformation may occur due to, at least, higher tolerances allowed during manufacturing. While higher tolerances may allow for increased cost savings during manufacturing (e.g., to produce low cost RISs), higher tolerances may inevitably allow for minor errors during manufacturing. In particular, the small size of RIS elements fabricated on the surface of a RIS (e.g., a RIS may be a 0.5 m×0.5 m square with 10,000 RIS elements) in combination with higher manufacturing tolerances may result in less than perfect fabrication of the RIS elements on the surface of the RIS. For example, in some cases, a RIS element may be displaced from its intended location on the RIS' surface by a few millimeters (mm). Although small, such deformation may result in significant phase changes. For example, at 28 gighertaz (gHz), a RIS element displacement of 0.6 mm from an intended location of the RIS element on a surface of a RIS may result in a phase deviation of Tr/, when compared to an expected reflection phase response for the RIS element.

Further, low cost materials may be used to fabricate RISs. Some low cost materials may not maintain shape when subjected to thermal stressors, external forces, and/or the like. Thus, deformation of a RIS may occur following deployment of the RIS, which may result in changes to location(s) and/or orientation(s) of one or more RIS elements on the RIS. Additionally, structures where RISs are deployed (e.g., billboards, aerial platforms, etc.) may also deform over time (e.g., due to thermal stressors, external forces, and/or the like). Deformation of a supporting structure of a RIS may lead to deformation of one or more RIS elements of the RIS. For example, ambient temperature changes may result in expansion or contraction of a supporting structure where a RIS is deployed. Expansion or contraction of a supporting structure may also cause one or more RIS elements of the RIS to deform.

In certain aspects, RIS deformation may occur during the assembling, packaging, and/or transportation of a RIS to a deployment site.

In certain aspects, deformation of RIS element(s) may be attributed to manufacturing larger sized RISes.

It should be noted that the above-described causes of RIS element deformation are only examples. In other words, the above-described causes of RIS element deformation are not an exhaustive list, and other things may occur to cause deformation to a structure supporting a RIS, the RIS itself, and/or RIS elements of the RIS.

RIS element deformations may induce structured (e.g., independently and identically distributed (IID) random) phase errors in RIS-assisted communications. For example, a precoding weight selected to configure a RIS element may enable the RIS element to tune the phase shift (and/or amplitude) of an incident radio signal. If the RIS element is deformed (e.g., a location and/or orientation change from what is expected for the RIS element), however, then the resulting phase response of the modified incident signal may deviate from what is expected.

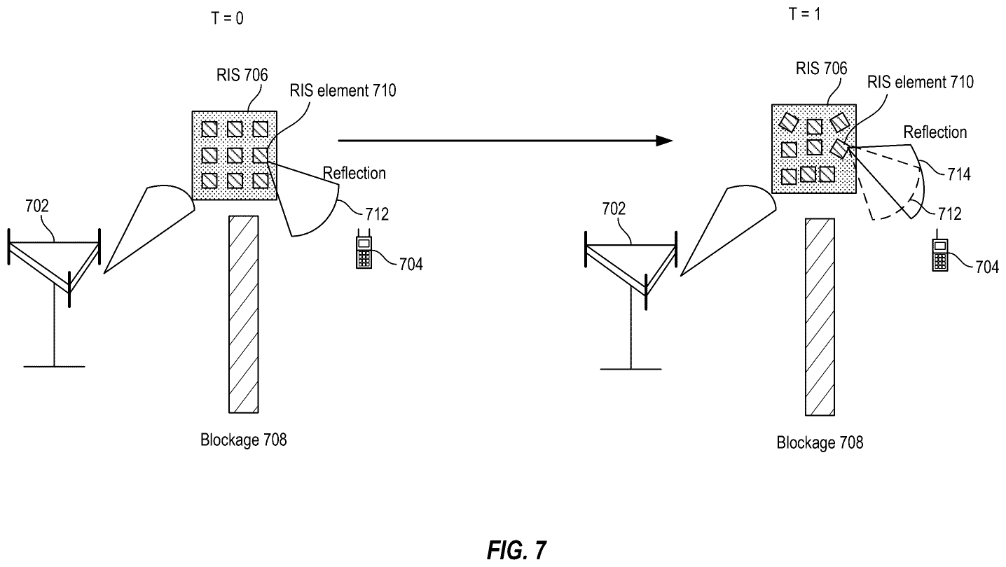

FIG. 7 depicts example phase errors resulting from RIS element deformation. As shown in FIG. 7, a RIS 706 (e.g., such as RIS 106 of FIGS. 1 and 3) may be deployed to assist communications between a network entity 702 (e.g., such BS 102 of FIGS. 1 and 3, and/or a disaggregated base station as discussed with respect to FIG. 2) and a UE 704 (e.g., such as UE 104 of FIGS. 1 and 3). More specifically, RIS 706 may be used to reflect radio signals between network entity 702 and UE 704 to bypass blockage 708. Thus, two-way communications between network entity 702 and first UE 704 may be enabled by RIS 706.

As shown in FIG. 7, when RIS 706 is initially deployed in a wireless communications environment including network entity 702 and UE 704 (e.g., at time T=0), the RIS elements are not deformed. For example, RIS element 710 is properly located and oriented on RIS 706 (e.g., according to a specification, design, etc.). RIS element 710 may reflect a radio signal in a first direction, depicted by an output beam 712 in a first direction in FIG. 7. The first direction may be a direction towards UE 704.

However, some time after deployment (e.g., at time T=1), multiple RIS elements, including RIS element 710, may be deformed. The RIS elements may have changed their locations with respect to a fixed reference point (e.g., translated left, right, up, down, etc.), changed their orientations (e.g., tilted up, tilted down, rotated left, rotated right, etc.), or both (e.g., bend-type deformations). For example, RIS element 710 may have translated right and rotated right. As such, a radio signal modified by RIS element 710 may be reflected in a different direction (e.g., with a different phase shift) than a same radio signal reflected by RIS element 710 when RIS element 710 was not deformed. For example, RIS element 710, at time T=1, may reflect a radio signal in a second direction, depicted by an output beam 714 in a second direction in FIG. 7. The second direction may be different than the first direction. For example, the output beam 714 (e.g., at time T=1, when RIS element 710 is deformed) may be different than the output beam 712 (e.g., at time T=0, when RIS element 710 is not deformed). The second direction may not necessarily be towards UE 704; thus, the quality of the radio signal received at UE 704 may be degraded.

Accordingly, at least as shown in FIG. 7, RIS element deformation may reduce the performance of RIS-assisted communications.

In some conventional approaches, offline testing of each RIS element is performed to determine a deformation of each RIS element following deployment. For example, after deploying a RIS in a wireless communications network (e.g., installing the RIS on a structure to assist communications in the network), the RIS may be taken offline, and each RIS element may be individually tested to determine the specific deformation of each RIS element. This deformation information may then be used to update a precoding weight applied to one or more RIS elements determined to be deformed. This update in precoding weight(s) may help to compensate for phase error(s) resulting from such deformation(s). While this may help to mitigate RIS element deformation, this approach may be time-consuming (and relatedly costly) and/or may not account for any future changes in location and/or orientation of the RIS element(s) (e.g., thereby requiring this process to again be performed in the future to compensate for further deformation(s)).

### Aspects Related to RIS Deformation Mitigation

Aspects described herein overcome the aforementioned technical problems by providing various methods that may be used to mitigate RIS deformation. In certain aspects, the methods may be used to mitigate deformation of individual RIS elements. In certain aspects, the methods may be used to mitigate deformation for a group of RIS elements (e.g., for multiple RIS elements belonging to a same group). In certain aspects, the methods may be used to mitigate RIS deformation in an on-line field setting, such as after a RIS has been deployed for assisting wireless communications between nodes.

As described in detail below, RIS deformation mitigation may include estimating the deformation for at least one RIS element of a previously-deployed RIS. Once the nature of the deformation is assessed, RIS deformation mitigation may include determining and performing a codebook update for at least the one RIS element to compensate for the estimated deformation. Such RIS deformation mitigation may help to mitigate the impact from evolving, time-varying deformations of RIS elements, which may be critical to maintain performance of the RIS.

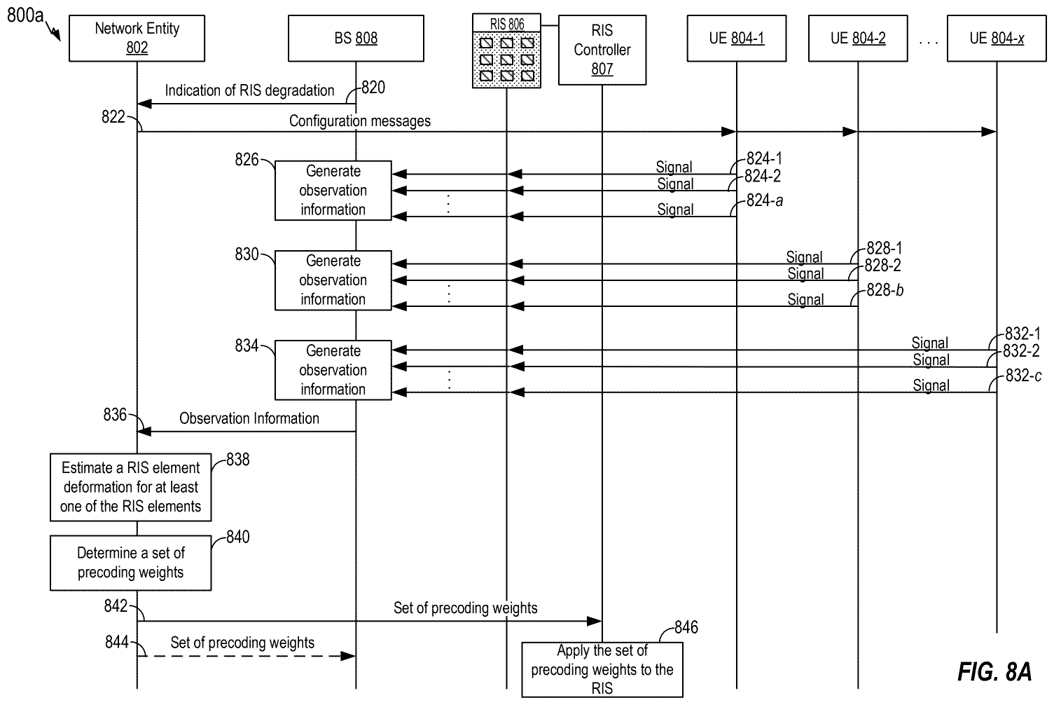

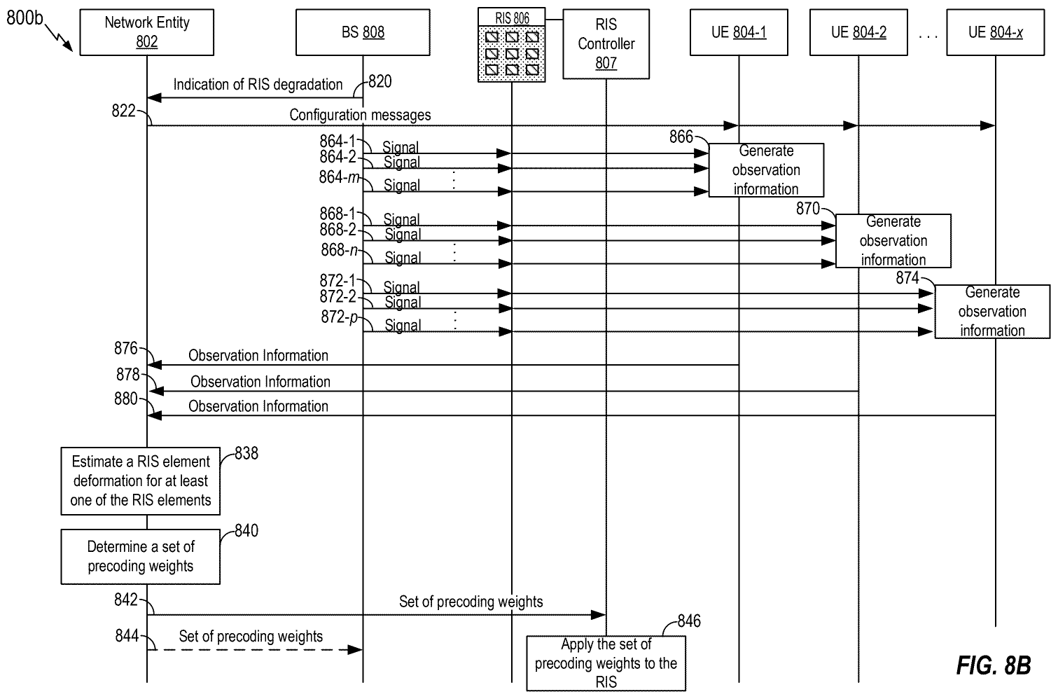

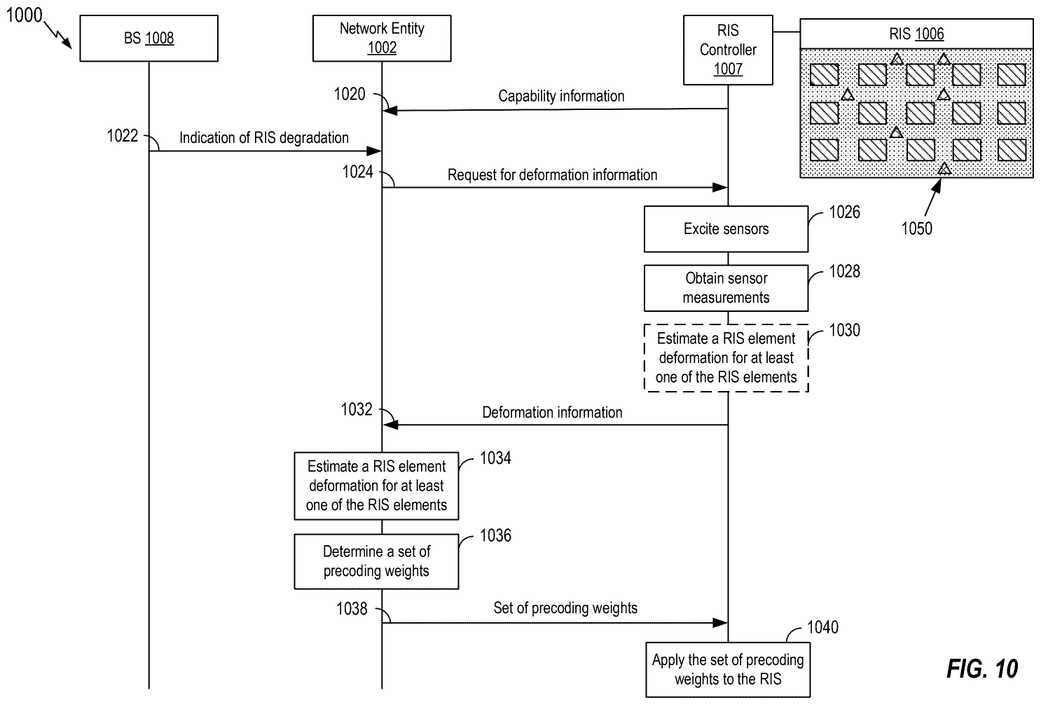

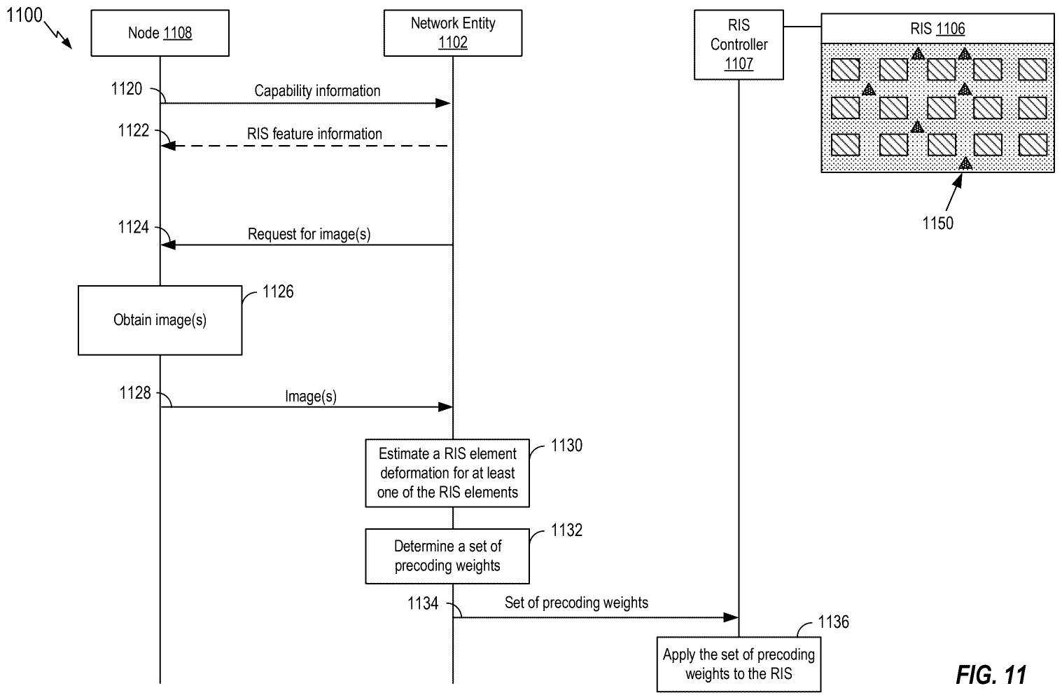

A first method, depicted and described below with respect to FIGS. 8A and 8B uses observation information obtained from radio signals communicated between nodes using a deformed RIS to estimate deformation for one or more RIS elements. A second method, depicted and described below with respect to FIG. 10, uses sensor information to estimate RIS element deformation. A third method, depicted and described below with respect to FIG. 11, uses image(s) of RIS element(s) to estimate deformation for the RIS element(s). For all aforementioned methods, the estimated RIS element deformation may be used to update a codebook such that RIS-assistance performance is improved even when one or more of the RIS' elements are deformed. Put differently, the update to the codebook may help to compensate for phase errors occurring as a result of the deformation such that RIS-assisted communication is improved.

### Example Signaling for a First RIS Deformation Mitigation Method

FIGS. 8A and 8B each depict a process flow 800a, 800b, respectively, for communications in a network between a network entity 802, UEs 804-1 through 804-x (collectively referred to herein as UEs 804), a RIS 806, a BS 808, and a RIS controller 807, used to control RIS 806. In certain aspects, the network entity 802 and/or BS 808 may be an example of the BS 102 depicted and described with respect to FIGS. 1 and 3 or a disaggregated base station depicted and described with respect to FIG. 2. However, in other aspects, network entity 802 and/or BS 808 may be another type of network entity or network node, such as those described herein. Similarly, the UEs 804-1 through 804-x may each be an example of UE 104 depicted and described with respect to FIGS. 1 and 3. However, in other aspects, UEs 804 may be another type of wireless communications device. In certain aspects, the RIS 806 may be an example of RIS 106 depicted and described with respect to FIGS. 1 and 3, and RIS controller 807 may be an example of RIS controller 103 depicted and described with respect to FIGS. 1 and 3.

Note that any operations or signaling illustrated with dashed lines may indicate that that operation or signaling is an optional or alternative example.

Process flows 800a, 800b may be used to estimate the deformation for one or more RIS elements of RIS 806 and update a codebook based on the estimated deformation. Signaling depicted and described with respect to process flows 800a, 800b may be used to obtain observation information for deformation estimation such that these steps can be performed to mitigate RIS element deformation.

Process flow 800a in FIG. 8A begins, at 820, with network entity 802 receiving, from BS 808, an indication of RIS 806 degradation or a capability enabling RIS array shape change mitigation. For example, BS 808 may be a node receiving communication assistance from RIS 806. Put differently, BS 808 may be a node that uses RIS 806 to send and/or receive communications from other node(s) in the wireless communications network. In certain aspects, BS 808 may determine RIS degradation of RIS 806 (e.g., that the RIS-assisted communication is degraded) based on a signal quality of a radio signal received at BS 808. For example, a reference signal received power (RSRP) of a radio signal reflected from RIS 806, and received by BS 808, may be below a threshold value (e.g., low RSRP thereby indicating RIS degradation). In certain aspects, the indication of RIS degradation may be provided to network entity 802, from BS 808, as a measurement report including one or more measurements obtained by BS 808.

In certain aspects, BS 808 may employ retro-reflection techniques, i.e., configure RIS 806 to reflect incident signals from BS 808 back to BS 808, to determine whether communication via RIS 806 is degraded. For example, BS 808 may send pilot signals towards RIS 806, which may then be reflected back to BS 808. BS 808 may measure the strength of the reflected signals to assess whether deformations-related degradation needs to be corrected for RIS 806.

In certain aspects, BS 808 may proactively request sensor readings associated with RIS 806 to determine RIS degradation of RIS 806.

In certain aspects, the indication of RIS degradation, received by network entity 802 at 820, may serve as a trigger, to network entity 802, to begin a RIS deformation mitigation process. Accordingly, based on receiving the indication, network entity 802 may begin the RIS deformation mitigation process.

The RIS deformation mitigation process includes network entity 802 configuring multiple “helper nodes” (also referred to herein as “buddy nodes”). In certain aspects, network entity 802 configures multiple helper nodes to transmit signals to one or more other nodes via RIS 806 (e.g., the degraded RIS) to thereby trigger the other node(s) to generate observation information associated with each of the pilot signal(s). The observation information may be information that is configured to be used for adjusting a codebook pattern (e.g., precoding weights applied to RIS element(s)) of RIS 806. In certain other aspects, network entity 802 configures multiple helper nodes to receive signals from one or more other nodes via RIS 806 (e.g., the degraded RIS) and generate observation information for the received signals, which may be used for adjusting a codebook pattern of RIS 806.

In certain aspects, the signals transmitted by the helper nodes and/or received at the helper nodes are pilot signals. Pilot signals may refer to known signals (e.g., theirs scheduled positions within slots are known to receivers of the pilot signals) generally associated with a group of frequencies (e.g., subcarriers). In certain aspects, pilot signals may be utilized for channel measurement and/or estimation.

FIG. 8A depicts the case where multiple helper nodes are configured to transmit signals to another node to trigger the other node to generate observation information based on the signals. FIG. 8B (described in detail below) depicts the case where multiple helper nodes are configured to receive signals from the other node and generate observation information based on the signals.

Specifically, as shown in FIG. 8A, at 822, network entity 802 sends a configuration message to each of UEs 804-1 through 804-x. The configuration messages may configure UEs 804-1 through 804-x with resources (e.g., time-frequency resources) for sending signals (e.g., pilot signals) to BS 808 (e.g., in other words, network entity 802 sends, to each UE 804, a configuration of resources). Further, the configuration messages may include instructions instructing UEs 804-1 through 804-x to send signals to BS 808 using the configured resources. In FIG. 8A, UEs 804 may be the helper nodes configured by network entity 802. A number of helper nodes configured by network entity 802 may be determined by network entity 802. In certain aspects, in addition to configuring UEs 804 with the time-frequency resources, network entity 802 additionally configures UEs 804 with attributes for sending the signals to BS 808, such as pilot attributes where UEs 804 send pilot signals to BS 808. The pilot attributes may include transmit beams (or receive beams, where UEs 804 alternatively receive the pilot signals) to use for communicating the pilot signals, a transmit power, a spreading sequence, a repetition factor, and/or the like.

At 824 (e.g., 824-1, 824-2, . . . 824-a), a first helper node, UE 804-1, sends, to BS 808, one or more signals via the configured resources. A number of signals sent by UE 804-1 may be based at least in part on a number of resources that network entity 802 configures UE 804-1 to use for sending the signals. In this example, UE 804-1 sends a first signal at 824-1, sends a second signal at 824-2, through an a-th signal sent at 824-a (e.g., where a is an integer greater than zero).

The signals sent, by UE 804-1 to BS 808, may be sent to BS 808 via RIS 806. For example, RIS 806 may be used to modify each signal sent, by UE 804-1 to BS 808 at 824, towards BS 808.

At 826, BS 808 generates observation information for the signals received at 824. For example, in certain aspects, BS 808 measures the different signals received to determine one or more measurements for each of the signals. The observation information associated with a signal may include the one or more measurements, which may in some cases include RSRP. In certain aspects, the observation information associated with a signal may alternatively, or additionally, include one or more in-phase and quadrature (IQ) samples (e.g., a complex number that represents the phase and amplitude of the signal). In certain aspects, only quantized observations may be generated at 826.

In certain aspects, the observation information associated with a signal may alternatively, or additionally, include one or more phase estimations. For example, BS 808 may obtain supporting information such as channel estimate(s) and/or a RIS calibration codebook. With this supporting information, BS 808 may perform calibration for each helper node, e.g., for each UE 804, and determine a set of phases for the received signals. These phases, which may vary across UEs 804, may indicate the net impact of deformation and/or, in some cases, other RIS element phase drifts.

Similarly, at 828 (e.g., 828-1, 828-2, . . . 828-b), a second helper node, UE 804-2, sends, to BS 808, one or more signals via the configured resources. At 830, BS 808 generates observation information for the signals received at 828.

This process repeats for each helper node until an xth helper node, UE 804-x, sends, to BS 808, one or more signals via the configured resources, at 832 (e.g., 832-1, 832-2, . . . 832-c), and BS 808 generates observation information for the signals received at 834.

At 836, BS 808 sends, to network entity 802, the observation information (e.g., generated at 826, 830, . . . 834). In certain aspects, BS 808 sends the observation information to network entity 802 as one or more reports. In certain aspects, BS 808 sends the observation information to network entity 802 as one or more transmissions (although only one transmission is shown in FIG. 8A).

At 838, network entity 802 estimates a RIS element deformation for at least one of the RIS elements of RIS 806. Network entity 802 may estimate at least one RIS element deformation based at least in part on the observation information received at 836 and a deformation database. In certain aspects, network entity 802 may estimate at least one RIS element deformation based at least in part on additional supporting information, such as channel estimate(s) between helper nodes and RIS elements, helper node transmission location(s) relative to a RIS reference, helper node reception location(s) relative to a RIS reference, and/or a calibration codebook used at RIS 806 and RIS controller 807.

For example, in certain aspects, network entity 802 may be (pre) configured to use a deformation database. In certain aspects, network entity 802 may receive signaling configuring network entity 802 to use the deformation database. The deformation database may provide a mapping between a plurality of RIS element deformations and one or more observations expected for each of the plurality of RIS element deformations. For example, a first mapping may indicate a correlation between a first phase estimation (e.g., a first observation) and a first RIS element deformation, while a second mapping may indicate a correlation between a second phase estimation (e.g., a second observation) and a second RIS element deformation. In certain aspects, the RIS element deformations that are possible for RIS elements of RIS 806 include different RIS element bend types, different RIS element bend angles, different RIS element tilt types, different RIS element tilt angles, and/or different RIS element translations in a plane (e.g., virtual translations, horizontal translations, etc.). These RIS elements deformations may be categorized into location changes and orientation changes (e.g., RIS element deformations estimated for one or more RIS elements of RIS 806).

In certain aspects, the deformation database provides RIS element deformations (and their associated expected observations) at different granularities. For example, the deformation database may provide RIS element deformations (and their expected observations) for a single RIS element of RIS 806, multiple RIS elements belonging to a same RIS element group, multiple RIS elements associated with a sub-array (also referred to herein as a “sub-panel”) of RIS 806, multiple RIS elements associated with a pattern (e.g., a first pattern including every other RIS element, a second pattern including RIS elements in a cross-shape, etc.), and/or multiple RIS elements associated with and/or (4) for all RIS elements of RIS 806.

In certain aspects, the deformation database configured for use by network entity 802 provides mappings that are specific to RIS elements of RIS 806. Put differently, the RIS element deformations included in the deformation database are deformations that are likely and/or deformations that may be expected specifically for RIS elements of RIS 806 (e.g., based on the manufacturing tolerances used to manufacture RIS 806, based on the material of RIS 806, based on the mounting structure of RIS 806, etc.).

In certain aspects, network entity 802 may receive one or more updates to the deformation database used to estimate a RIS element deformation for at least one of the RIS elements of RIS 806.

After estimating a RIS element deformation for at least one of the RIS elements, at 840, network entity 802 determines a set of precoding weights. For example, based on the estimated deformation of a first RIS element of RIS 806, network entity 802 may determine a phase shift to be applied by the RIS element (e.g., the RIS element is configured to apply a phase shift) such that signals sent by the RIS element (e.g., reflected, refracted, etc.) are more accurate. Put differently, the phase shift to be applied by the RIS element may be used to compensate for the change in orientation and/or location (e.g., deformation) of the RIS element. The set of precoding weights may include precoding weights associated with one or more of the RIS elements of RIS 806.

At 842, network entity 802 sends, to RIS controller 807, the set of precoding weights. RIS controller 807 may use the set of precoding weights to update the codebook for RIS 806 and apply the set of precoding weights to RIS 806 (e.g., to RIS elements of RIS 806), at 846.

Optionally, at 844, network entity 802 sends, to BS 808, the set of precoding weights. Network entity 802 may send the set of precoding weights to BS 808 such that BS 808 is aware of the updated precoding weights for RIS 806. Assuming process flow 800a is again performed to determine deformations of the RIS elements, at a later time in the future, BS 808 may use these updated precoding weights to determine new phase estimates that may then be reported back to network entity 802.

It is noted that process flow 800a may be performed many times over a period of time. Performing process flow 800a continuously, periodically, etc. may help to ensure that deformations of the RIS elements, over time, are accurately being compensated for.

Process flow 800b depicts in FIG. 8B is similar to process flow 800a depicted in FIG. 8A; however, instead of configuring helper nodes to transmit signals, the helper nodes are configured to receive signals and determine the observation information. In particular, steps 820, 822, and 838-846 in FIG. 8B are similar to steps 820, 822, and 838-846 in FIG. 8B. However, different from FIG. 8A, instead of UEs 804 sending signals to BS 808 at 824, 828 . . . 832, UEs 804 receive signals from BS 808, at 864, 868, . . . 872 in FIG. 8B. To receive the signals from BS 808, the configuration messages sent to UEs 804, at 822, may configure UEs 804 with resources (e.g., time-frequency resources) for receiving signals (e.g., pilot signals) from BS 808. The configuration messages may include instructions instructing each respective UE 804 to generate observation information for signal(s) received at the respective UE (e.g., instruct UE 804-1 to generate observation information based on signal(s) received by UE 804-1, instruct UE 804-2 to generate observation information based on signal(s) received by UE 804-2, etc.). This is different from FIG. 8A where BS 808 generates the observation information. Further, the configuration messages may include instructions instructing each respective UE 804 to send their generated observation information to network entity 802 (e.g., such as using dedicated resources and/or a dedicated message).

For example, at 864 (e.g., 864-1, 864-2, . . . 864-m), BS 808 sends, to the first helper node, UE 804-1, one or more signals via configured resources. At 866, UE 804-1 generates observation information for the signals received at 864.

At 868 (e.g., 868-1, 868-2, . . . 868-n), BS 808 sends, to the second helper node, UE 804-2, one or more signals via configured resources. At 870, UE 804-2 generates observation information for the signals received at 868.

This process repeats for each helper node until an xth helper node, UE 804-x, receives, from BS 808, one or more signals via the configured resources, at 872 (e.g., 872-1, 872-2, . . . 872-p), and UE 804-x generates observation information for the signals received at 872.

Also unlike FIG. 8A, UEs 804 send the observation information to network entity 802, at 876, 878, . . . , 880, instead of network entity 802 sending the observation information to network entity 802.

Note that the process flows 800a, 800b illustrated in FIGS. 8A and 8B, respectively, are described herein to facilitate an understanding of RIS deformation mitigation, and aspects of the present disclosure may be performed in various manners via alternative or additional signaling and/or operations. In certain aspects, the operations and/or signaling of FIGS. 8A and 8B may occur in an order different from that described or depicted, and various actions, operations, and/or signaling may be added, omitted, or combined.

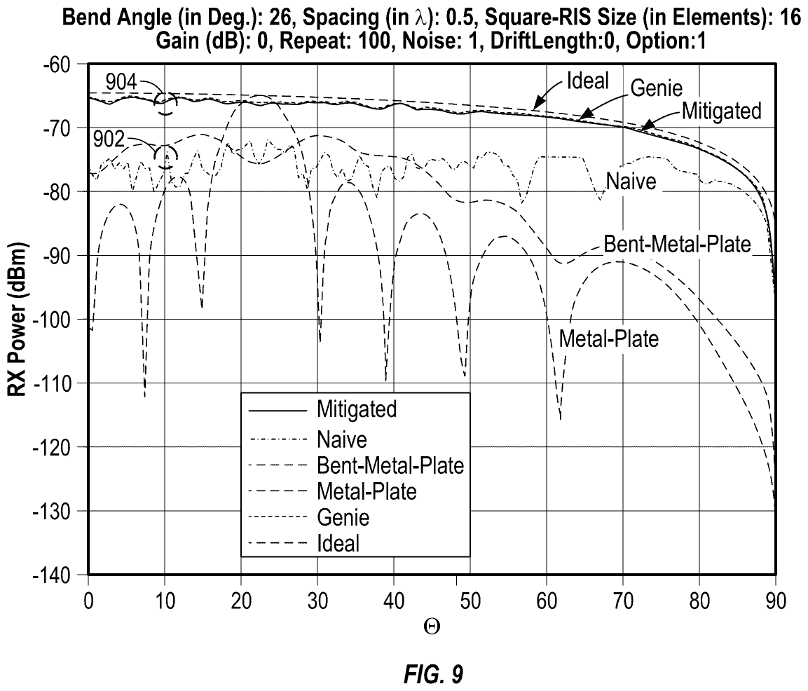

FIG. 9 depicts example RIS-assisted communication performance gain using RIS deformation mitigation techniques described herein, such as the first RIS deformation mitigation method described in either FIG. 8A or FIG. 8B. FIG. 9 specifically depicts the performance gain for a 16×16 quaternary alphabet RIS with λ/2 spacing, which has been deformed. For example, the RIS may have a true bend angle of 26° and a true tilt of 0°. An incident signal may be along θᵢ=−22.34° from boresight.

FIG. 9 depicts RIS-assisted communication performance when deformation of the RIS is ignored, shown as the “Naive” case, deformation of the RIS is non-existent, shown as the “Ideal” case, deformation of the RIS is mitigated via process flow 800a and/or process flow 800b, shown as the “Mitigated” case, and (4) deformation of the RIS is mitigated using a prediction model, shown as the “Genie” case. FIG. 9 also compares RIS-assisted performance of the 16×16 quaternary alphabet RIS with (5) a flat metal plate RIS with same dimensions as the 16×16 quaternary alphabet RIS, shown as the “Metal-Plate” case and (6) a metal plate with the same bend and dimensions as the 16×16 quaternary alphabet RIS, shown vas the “Bent-Metal-Plate” case.

As shown, using the first RIS deformation mitigation method, RIS-assisted performance may improve by approximately 10 dBm. For example, at θ=10 (x-axis), the “Naive” case (e.g., where RIS deformation is ignored) has approximately a −75 dBm receive power (e.g., shown at 902 in FIG. 9), while the “Mitigated” case (e.g., where RIS deformation is mitigated) has approximately at −65 dBm receive power (e.g., shown at 904 in FIG. 9).

As such, use of the first RIS deformation mitigation method is effective to compensate for RIS deformation (e.g., RIS element(s) deformation) and thus improve RIS-assisted communication performance. Further, the first RIS deformation mitigation method is capable of achieving almost an ideal RIS-assisted communication performance (e.g., when compared to the “Ideal” case and the “Genie” case).

### Example Signaling for a Second RIS Deformation Mitigation Method

FIG. 10 depicts a process flow 1000 for communications in a network between a network entity 1002, a BS 1008, and a RIS controller 1007, used to control a RIS 1006. In certain aspects, the network entity 1002 and/or BS 1008 may be an example of the BS 102 depicted and described with respect to FIGS. 1 and 3 or a disaggregated base station depicted and described with respect to FIG. 2. However, in other aspects, network entity 1002 and/or BS 1008 may be another type of network entity or network node, such as those described herein. In certain aspects, the RIS 1006 may be an example of RIS 106 depicted and described with respect to FIGS. 1 and 3, and RIS controller 1007 may be an example of RIS controller 103 depicted and described with respect to FIGS. 1 and 3.

In certain aspects, one or more sensors 1050 are installed on the surface of RIS 1006. The sensor(s) 1050 may be configured to obtain deformation information (e.g., based on sensor reading(s)) for one or more RIS elements of RIS 1006 (e.g., including all RIS elements of RIS 1006). The sensor(s) 1050 may be uniformly or non-uniformly distributed across the surface of RIS 1006. In certain aspects, the sensor(s) 1050 include printed resistive sensor(s) for measuring changes in resistance due to deformation (e.g., strain). In certain aspects, the sensor(s) 1050 include Fiber Bragg Grating (FBG) sensor(s) for measuring optical wavelength shifts caused by strain. In certain aspects, the sensor(s) include sensor(s) for measuring (changes in) relative orientation, mutual-coupling, etc. In certain aspects, the sensor(s) 1050 installed on the surface of RIS 1006 are configured to measure specific RIS elements of RIS 1006, such that different sensors obtain deformation information for different RIS elements. For example, a first sensor 1050-1 may be configured to obtain deformation information (e.g., measurements) for a first set of ten RIS elements of RIS 1006 while a second sensor 1050-2 may be configured to obtain deformation information (e.g., measurements) for a second set of RIS elements of RIS 1006.

Note that any operations or signaling illustrated with dashed lines may indicate that that operation or signaling is an optional or alternative example.

Process flow 1000 may be used to estimate the deformation for one or more RIS elements of RIS 1006 and update a codebook based on the estimated deformation. Signaling depicted and described with respect to process flow 1000 may be used to obtain sensor information for deformation estimation such that these steps can be performed to mitigate RIS element deformation.

Process flow 1000 begins, at 1020 with RIS controller 1007 sending, to network entity 1002, and network entity 1002 receiving, capability information for RIS 1006. The capability information may indicate, to network entity 1002, that RIS 1006 includes sensor(s) 1050 and RIS 1006 (including RIS controller 1007) is capable of obtaining deformation information from the sensor(s) 1050. In certain aspects, the capability information further includes an indication of a time period when RIS 1006 is capable of obtaining the deformation information from sensor(s) 1050. In certain aspects, the capability information further includes an indication of a time period when RIS 1006 is not capable of obtaining the deformation information from sensor(s) 1050 (e.g., down-time of RIS 1006 and its sensor(s) 1050).

In certain aspects, the RIS elements of RIS 1006 may belong to (e.g., be assigned to) multiple groups. For example, a first subset of the RIS elements may belong to a first RIS element group, a second subset of the RIS elements may be long to a second RIS element group, etc. Thus, in some cases, the capability information further includes an indication of the RIS element groups for RIS 1006.

At 1022, BS 1008 sends, to network entity 1002, an indication of RIS 1006 degradation. The indication of RIS 1006 degradation may be similar to the indication of RIS 806 degradation depicted and described above with respect to FIGS. 8A and 8B (e.g., at 820).

In certain aspects, the indication of RIS degradation, received by network entity 1002 at 1022, may serve as a trigger, to network entity 1002, to begin a RIS deformation mitigation process. Accordingly, based on receiving the indication, network entity 1002 may begin the RIS deformation mitigation process.

Accordingly, at 1024, network entity sends, to RIS controller 1007, a request for deformation information. In certain aspects, the request may indicate network entity 1002 is requesting deformation information from a subset of sensor(s) 1050 and thereby indicate the subset of sensor(s) 1050. The subset of sensor(s) 1050 may be associated with one or more of the RIS elements of RIS 1006.

In certain aspects, the request for deformation information includes a request to obtain deformation information for one or more specific RIS element groups. The sensor(s) 1050 use to obtain the deformation information may be associated with the specific RIS element group(s).

In certain aspects, the request for deformation information further includes a time period to obtain the deformation information. Thus, based on receiving the request, RIS controller 1007 may determine if the sensor(s) 1050 are available to obtain the deformation during the time period. If the sensor(s) 1050 are not available, RIS controller 1007 may deny network entity 1002's request and send, to network entity 1002, an indication that the request has been denied. For example, sensor(s) 1050 may not be available during the time period if they are assisting communications between other nodes. Alternatively, if the sensor(s) 1050 are available, RIS controller 1007 may accept network entity 1002's request and, in some cases, send, to network entity 1002, an indication that the request has been accepted and RIS controller 1007 and RIS 1006 will proceed with obtaining the deformation information during the requested time period. In other cases, RIS controller 1007 may simply proceed with gathering the deformation information without sending the indication that the request has been accepted.

FIG. 10 assumes that RIS controller 1007 accepts the request. Thus, at 1026, RIS controller 1007 excites one or more sensors 1050 of RIS 1006 to begin obtaining deformation information for one or more RIS elements of RIS 1006. The deformation information may include one or more measurements associated with the RIS element(s) obtained by sensor(s) 1050 (e.g., referred to as “sensor measurements” and obtained at 1028). For example, the deformation information may include resistance changes information (e.g., due to deformation), optical wavelength shifts information, relative orientation or changes in relative orientation information, mutual-coupling information, and/or the like. RIS controller 1007 may receive the deformation information (e.g., sensor measurements) from sensor(s) 1050 of RIS 1006.

Optionally, at 1030, RIS controller 1007 may estimate a RIS element deformation for at least one of the RIS elements of RIS 1006. Network entity 1002 may estimate at least one RIS element deformation based at least in part on the deformation information (e.g., the measurement(s) obtained by sensor(s) 1050).

In certain aspects, at 1030, RIS controller 1007 may estimate a RIS element deformation for one or more RIS element groups. To estimate a RIS element deformation for a group of RIS elements, RIS controller 1007 may estimate a RIS element deformation only one RIS element in the group. This estimated RIS element deformation may then be assumed for entire group (e.g., all RIS elements in the RIS element group may be assumed to have the same RIS element deformation).

In certain aspects, at 1030, RIS controller 1007 may estimate a RIS element deformation for two or more RIS element groups. For example, RIS controller 1007 may estimate a first RIS element deformation for a first RIS element group (e.g., including a first subset of RIS elements) and a second RIS element deformation for a second RIS element group (e.g., including a second subset of RIS elements). To determine the first RIS element deformation and the second RIS element deformation, in certain aspects, RIS controller 1007 may estimate a RIS element deformation for only one RIS element in one of the first RIS element group or the second RIS element group. For example, RIS controller 1007 may determine a single orientation deformation (e.g., twist) for the first and second RIS element groups (e.g., based on a single RIS element belonging to one of the RIS element groups). However, in certain aspects, RIS controller may determine a location deformation (e.g., draft) for each RIS element group separately (e.g., determine a first location deformation for the first RIS element group and a second location deformation for the second RIS element group).

In certain aspects, at 1030, RIS controller 1007 may estimate a RIS element deformation for a sub-array of RIS 1006. For example, RIS 1006 may be broken down into sub-arrays, where each sub-array includes a subset of the RIS elements of RIS 1006. Further each sub-array may include one or more RIS element groups, and each RIS element group may include at least one RIS element. In certain aspects, RIS controller 1007 may estimate an orientation deformation (e.g., twist) for a first sub-array of RIS 1006. An orientation deformation of the first sub-array may impact illumination and/or result in a fraction of incident energy being received by the sub-array from a node (e.g., such as BS 1008) seeking communication assistance from RIS 1006. In particular, the energy incident, or landing, on the RIS 1006 post-deformation may be different than the energy incident on the RIS pre-deformation. For example, if the RIS 1006 tilts to face away from a source transmitting a signal to the RIS, then the energy incident on the RIS 1006 may significantly decrease. An orientation deformation of the first sub-array may also impact a field-of-view that can be served by RIS 1006 (e.g., via reflections and/or refractions).

In certain aspects, if the orientation deformation determined for the first sub-array, and/or supporting information, implies that RIS elements of that sub-array will receive very low incident energy from a node (e.g., seeking assistance from RIS 1006), then RIS controller 1007 may not (re) estimate position deformation(s) for one or more RIS element groups associated with the sub-array sub-groups. In other words, RIS controller 1007 may avoid estimating position deformation(s) for the sub-array (e.g., for RIS element group(s) of the sub-array). Optionally, in some cases, one or more of the RIS elements belonging to the sub-array may be deactivated for energy saving. In certain aspects, the supporting information includes sub-array dimensions, a distance between a center of RIS 1006 and the node, etc.

Similarly, if the orientation deformation determined for the first sub-array, and/or supporting information, implies that RIS elements of that sub-array will not be able to modify radio signals towards a target field-of-view, then RIS controller 1007 may not (re) estimate position deformation(s) for one or more RIS element groups associated with the sub-array sub-groups. In other words, RIS controller 1007 may avoid estimating position deformation(s) for the sub-array (e.g., for RIS element group(s) of the sub-array). Optionally, in some cases, one or more of the RIS elements belonging to the sub-array may be deactivated for energy saving.

At 1032, RIS controller 1007 sends, to network entity 1002, the deformation information. In certain aspects, the deformation information includes only the measurement(s) from sensor(s) 1050. The measurement(s) may be raw and/or processed (and quantized) prior to being sent. In certain aspects, the deformation information includes only the estimated RIS element deformation(s). In certain aspects, the deformation includes both the measurement(s) and the estimated RIS element deformation(s).

In certain aspects, RIS controller 1007 sends, to network entity 1002, the deformation information along with some supporting information. The supporting information may include stimulus (e.g., current/voltage values) given to sensor(s) 1050 associated with the obtained readings, look-up-tables (e.g., readings versus expected deformations), etc.

In certain aspects, the deformation information, sent at 1032 to network entity 1002, includes a sensor measurement matrix with supporting information that enables network entity 1002 to estimate deformation(s) for one or more RIS elements (e.g., such as position-drift(s), orientation-twist(s), etc.).

At 1034, network entity 1002 estimates a RIS element deformation for at least one of the RIS elements of RIS 1006. Network entity 1002 may estimate a RIS element deformation for at least one of the RIS elements based at least in part on the deformation information (e.g., received at 1032), e.g., the received measurement(s) and/or the received RIS element deformation(s).

In certain aspects, network entity 1002 determines the RIS element deformation at 1034 using similar techniques as RIS controller 1007, which are described above with respect to step 1030.

After estimating a RIS element deformation for at least one of the RIS elements, at 1036, network entity 1002 determines a set of precoding weights. For example, based on the estimated deformation of a first RIS element of RIS 1006, network entity 1002 may determine a phase shift to be applied by the RIS element such that signals sent by the RIS element (e.g., reflected, refracted, etc.) are more accurate. Put differently, the phase shift to be applied by the RIS element may be used to compensate for the change in orientation and/or location (e.g., deformation) of the RIS element. The set of precoding weights may include precoding weights associated with one or more of the RIS elements of RIS 1006.

At 1038, network entity 1002 sends, to RIS controller 1007, the set of precoding weights. RIS controller 1007 may use the set of precoding weights to update the codebook for RIS 1006 and apply the set of precoding weights to RIS 1006 (e.g., to RIS elements of RIS 1006), at 1040.

In certain aspects, to optimize signaling overhead correction vectors, the set of precoding weights may be sent per-codeword, per-group of codewords, and/or per-group of elements. The set of precoding weights may be sent with the caveat that RIS controller 1007 is aware of (e.g., configured with) an application of correction vectors to update the codebooks.

In certain other aspects, instead of network entity 1002 sending the set of precoding weights to RIS controller 1007, RIS controller 1007 may instead download the set of precoding weights. For example, network entity may send, to RIS controller 1007, signaling configuring RIS controller 1007 to download the set of precoding weights (not shown in FIG. 10).

Although FIG. 10 depicts RIS controller 1007 sending deformation information to network entity 1002, in certain aspects where RIS controller 1007 is capable of estimating a RIS element deformation for at least one of the RIS elements of RIS 1006, then the RIS controller 1007 may perform a self-update. For example, RIS controller 1007 may itself obtain deformation information, determine one or more RIS element deformations, determine an update to the codebook based on the estimated RIS element deformation(s), and apply the update (e.g., may not rely on network entity 1002 to perform these steps). In such cases, the RIS controller 1007 may be a more complex RIS controller 1007 capable of performing such s.

Note that the process flow illustrated in FIG. 10 is described herein to facilitate an understanding of RIS deformation mitigation, and aspects of the present disclosure may be performed in various manners via alternative or additional signaling and/or operations. In certain aspects, the operations and/or signaling of FIG. 10 may occur in an order different from that described or depicted, and various actions, operations, and/or signaling may be added, omitted, or combined.

### Example Signaling for a Third RIS Deformation Mitigation Method

FIG. 11 depicts a process flow 1100 for communications in a network between a network entity 1102, a node 1108, and a RIS controller 1107, used to control a RIS 1106. In certain aspects, the network entity 1102 and/or node 1108 may be an example of the BS 102 depicted and described with respect to FIGS. 1 and 3 or a disaggregated base station depicted and described with respect to FIG. 2. However, in other aspects, network entity 1102 and/or node 1108 may be another type of network entity or network node, such as those described herein. In certain aspects, the RIS 1106 may be an example of RIS 106 depicted and described with respect to FIGS. 1 and 3, and RIS controller 1107 may be an example of RIS controller 103 depicted and described with respect to FIGS. 1 and 3.

Note that any operations or signaling illustrated with dashed lines may indicate that that operation or signaling is an optional or alternative example.

Process flow 1100 may be used to estimate the deformation for one or more RIS elements of RIS 1106 and update a codebook based on the estimated deformation. Signaling depicted and described with respect to process flow 1100 may be used to obtain image(s) of RIS elements on RIS 1106 for deformation estimation such that these steps can be performed to mitigate RIS element deformation.

Process flow 1100 begins, at 1120 with node 1108 sending, to network entity 1102, and network entity 1102 receiving, capability information for node 1108. The capability information may indicate, to network entity 1102, that node 1108 includes one or more image sensors and that node 1108 is capable of obtaining to obtain images of RIS 1106 via the one or more image sensors. In certain aspects, the capability information may indicate that node 1108 is capable of capturing image(s) of one or more subsets of RIS elements on RIS 1106.

Optionally, at 1122, network entity 1102 may send, to node 1108, RIS feature information. The RIS feature information include information about one or more feature points 1150 installed on the surface of RIS 1106. The feature point(s) 1150 may comprise “position-markers” and/or “alignment-markers,” configured to assist node 1108, and more specifically image sensor(s) of node 1108, in obtaining image(s) of RIS 1106's elements. For example, the feature point(s) 1150 may help to compensate for offsets between an image sensor a non-deformed RIS orientation. Example feature point(s) 1150 may include uniquely colored point(s). Other example feature point(s) may include unique shapes implanted on RIS 1106, which may be used to match across images for 3D reconstruction and/or stereo correspondence.

At 1124, network entity sends, to node 1108, a request to obtain one or more images of RIS 1106. In certain aspects, the request may request to obtain image(s) of a subset of the RIS elements of RIS 1106.

In certain aspects, the request is a request to obtain image(s) for one or more specific RIS element groups. For example, the RIS elements of RIS 1106 may be grouped into one or more RIS element groups.

In certain aspects, the request for the image(s) further includes a time period to obtain the image(s). Thus, based on receiving the request, node 1108 may determine if the image sensor(s) of node 1108 are available to obtain the image(s) during the time period. If the image sensor(s) are not available, node 1108 may deny network entity 1102's request and send, to network entity 1102, an indication that the request has been denied. Alternatively, if the image sensor(s) are available, node 1108 may accept network entity 1102's request and, in some cases, send, to network entity 1102, an indication that the request has been accepted and node 1108 will proceed with obtaining the image(s) during the requested time period. In other cases, node 1108 may simply proceed with obtaining the image(s) without sending the indication that the request has been accepted.

FIG. 11 assumes that node 1108 accepts the request. Thus, at 1126, node 1108 obtains image(s) of a subset of the RIS elements of RIS 1106. At 1128, node 1108 sends the image(s) to network entity 1102. The image(s) provided to network entity 1102 may be raw and/or processed.

In certain aspects, image(s) may be provided to network entity 1102 as an image reading matrix associated with the image(s).

In certain aspects, node 1108 may additionally provide network entity 1102 with supporting information associated with the image(s). Example supporting information may include scale versus pixel color information table(s). Other example supporting information may include a matrix example, where a matrix may be used to enable stereo correspondence between images (for example relating a common point across multiple images).

In certain aspects, node 1108 may process the image(s) to determine one or more RIS element deformations, and thus provide these estimation(s) to network entity 1102 at 1126.

At 1130, network entity 1102 estimates a RIS element deformation for at least one of the RIS elements of RIS 1106. Network entity 1102 may estimate at least one RIS element deformation based at least in part on image(s) received from node 1108.

In certain aspects, network entity 1102 determines the RIS element deformation at 1130 using similar techniques as RIS controller 1007 and/or network entity 1002, which are described above with respect to steps 1030 and/or 1034 in FIG. 10.

After estimating a RIS element deformation for at least one of the RIS elements, at 1132, network entity 1102 determines a set of precoding weights. The set of precoding weights may include precoding weights associated with one or more of the RIS elements of RIS 1106.

At 1134, network entity 1102 sends, to RIS controller 1107, the set of precoding weights. RIS controller 1107 may use the set of precoding weights to update the codebook for RIS 1106 and apply the set of precoding weights to RIS 1106 (e.g., to RIS elements of RIS 1106), at 1136.

Note that the process flow illustrated in FIG. 11 is described herein to facilitate an understanding of RIS deformation mitigation, and aspects of the present disclosure may be performed in various manners via alternative or additional signaling and/or operations. In certain aspects, the operations and/or signaling of FIG. 11 may occur in an order different from that described or depicted, and various actions, operations, and/or signaling may be added, omitted, or combined.

### Example Operations

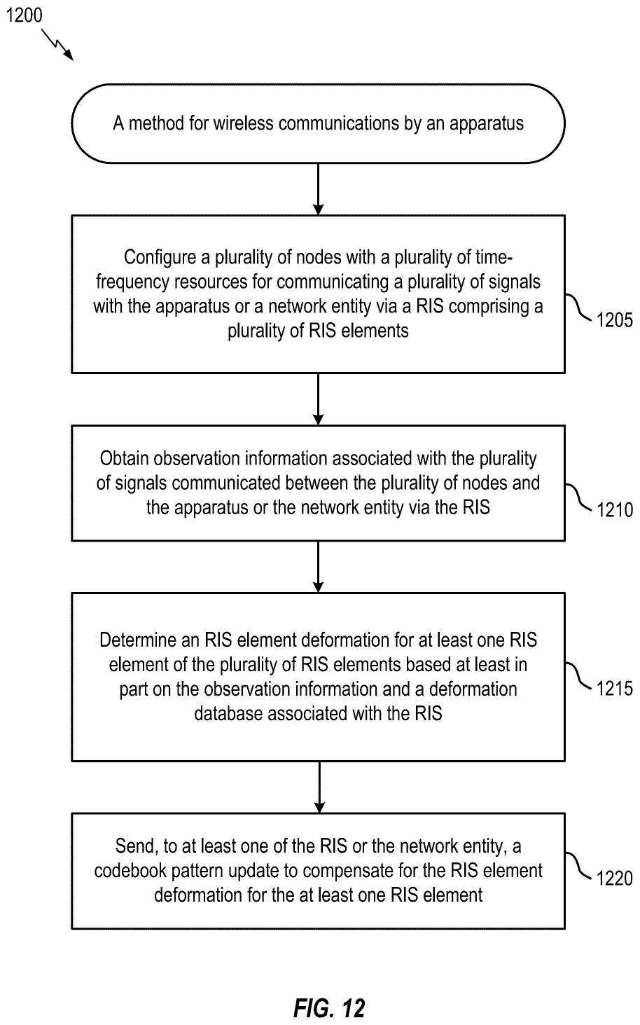

FIG. 12 shows a method 1200 for wireless communications by an apparatus, such as BS 102 of FIGS. 1 and 3, or a disaggregated base station as discussed with respect to FIG. 2.

Method 1200 begins at block 1205 with configuring a plurality of nodes with a plurality of time-frequency resources for communicating a plurality of signals with the apparatus or a network entity via a RIS comprising a plurality of RIS elements.

Method 1200 then proceeds to block 1210 with obtaining observation information associated with the plurality of signals communicated between the plurality of nodes and the apparatus or the network entity via the RIS.

Method 1200 then proceeds to block 1215 with determining an RIS element deformation for at least one RIS element of the plurality of RIS elements based at least in part on the observation information and a deformation database associated with the RIS. In certain aspects, the deformation database may provide a mapping between a plurality of RIS element deformations and one or more observations expected for each of the plurality of RIS element deformations. In certain aspects, determining the RIS element deformation for at least one RIS element comprises estimating the RIS element deformation for the at least one RIS element.

Method 1200 then proceeds to block 1220 with sending, to at least one of the RIS or the network entity, a codebook pattern update to compensate for the RIS element deformation for the at least one RIS element.

In certain aspects, the observation information associated with the plurality of signals includes at least one of: one or more in-phase and quadrature (IQ) samples; one or more reference signal received power (RSRP) measurements; or one or more phase estimates.

In certain aspects, method 1200 further includes receiving an update to the deformation database.

In certain aspects, sending the codebook pattern update at block 220 includes determining a set of precoding weights based at least in part on the estimated RIS element deformation for the at least one RIS element of the plurality of RIS elements; and sending, to at least one of the RIS or the network entity, the set of precoding weights.

In one aspect, block 1205 includes configuring the plurality of nodes with the plurality of time-frequency resources for transmitting the plurality of signals to the network entity via the RIS; and block 1210 includes obtaining the observation information from the network entity.

In one aspect, block 1205 includes configuring the plurality of nodes with the plurality of time-frequency resources for receiving the plurality of signals from the apparatus or the network entity via the RIS; and block 1210 includes obtaining the observation information from the plurality of nodes.

In certain aspects, method 1200 further includes sending the plurality of signals to the plurality of nodes via the RIS.

In one aspect, block 1205 includes configuring the plurality of nodes with the plurality of time-frequency resources for transmitting the plurality of signals to the apparatus via the RIS; and block 1210 includes determining the observation information based on the plurality of signals.

In certain aspects, method 1200 further includes configuring the plurality of nodes with a plurality of signal attributes for communicating the plurality of signals, the plurality of signal attributes comprising at least a plurality of transmit beams or a plurality of receive beams for communicating the plurality of signals.

In one aspect, the plurality of RIS element deformations included in the deformation database comprise one or more of: a plurality of RIS element bend types; a plurality of RIS element bend angles; a plurality of RIS element tilt types; a plurality of RIS element tilt angles; or a plurality of RIS element translations.

In one aspect, the RIS element deformation determined for the at least one RIS element comprises at least one of: a location change; or an orientation change.

In certain aspects, method 1200 further includes receiving an indication of a degradation of the RIS; and block 1205 includes configuring the plurality of nodes based on receiving the indication.

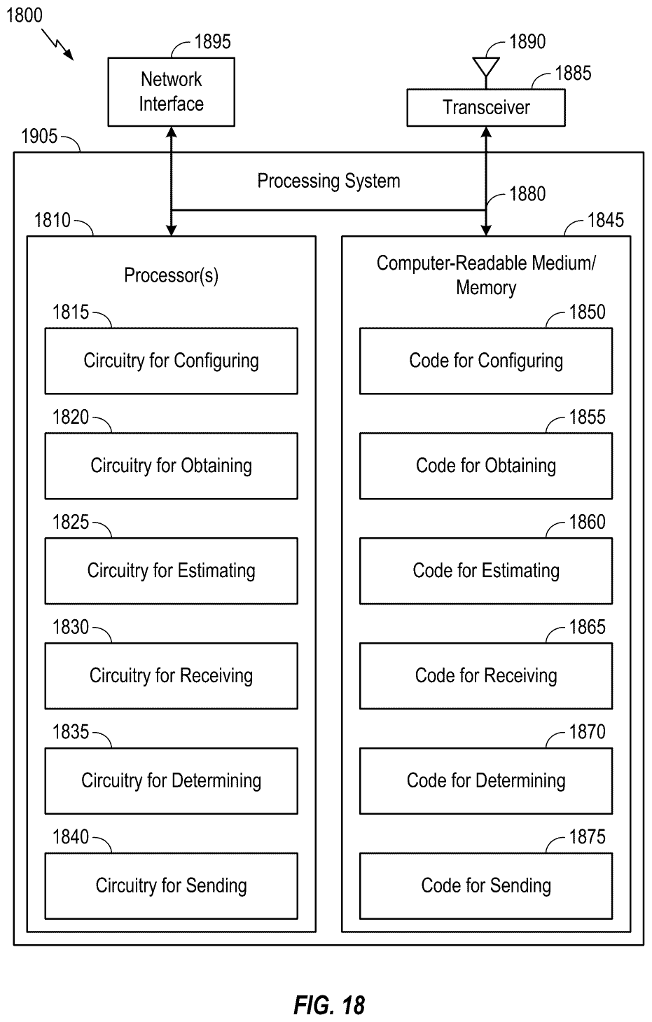

In one aspect, method 1200, or any aspect related to it, may be performed by an apparatus, such as communications device 1800 of FIG. 18, which includes various components operable, configured, or adapted to perform the method 1200. Communications device 1800 is described below in further detail.

Note that FIG. 12 is just one example of a method, and other methods including fewer, additional, or alternative operations are possible consistent with this disclosure.

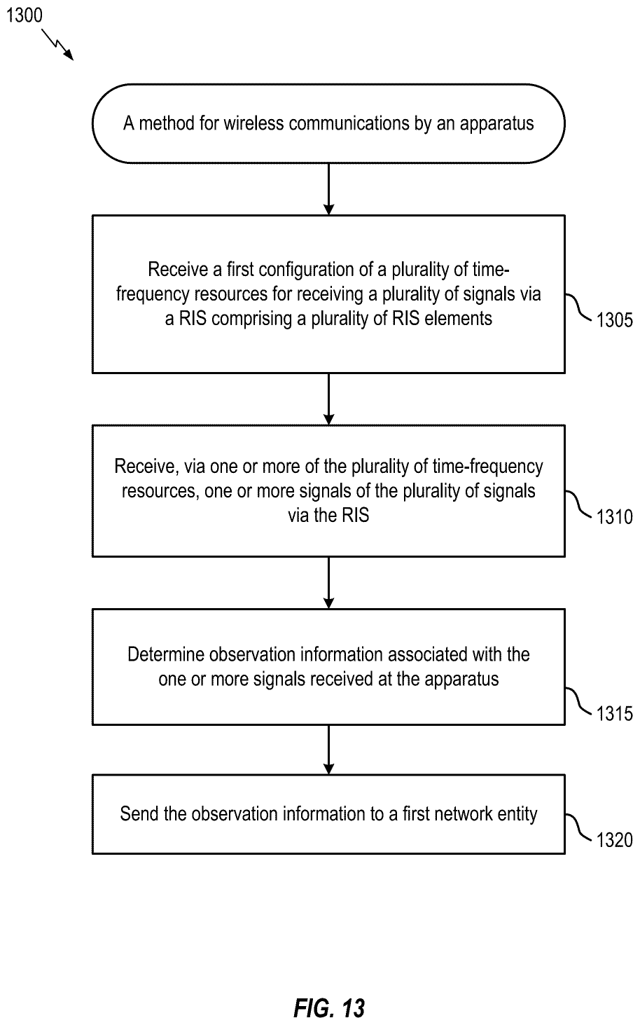

FIG. 13 shows a method 1300 of wireless communications by an apparatus, such as UE 104 of FIGS. 1 and 3, BS 102 of FIGS. 1 and 3, or a disaggregated base station discussed with respect to FIG. 2.

Method 1300 begins at block 1305 with receiving a first configuration of a plurality of time-frequency resources for receiving a plurality of signals via a RIS comprising a plurality of RIS elements.

Method 1300 then proceeds to block 1310 with receiving, via one or more of the plurality of time-frequency resources, one or more signals of the plurality of signals via the RIS.

Method 1300 then proceeds to block 1315 with determining observation information associated with the one or more signals received at the apparatus. In certain aspects, the observation information may include one or more in-phase and quadrature (IQ) samples, one or more reference signal received power (RSRP) measurements, and/or or one or more phase estimations. In certain aspects, the observation information may be configured to be used for adjusting a codebook pattern.

Method 1300 then proceeds to block 1320 with sending the observation information to a first network entity.

In one aspect, the apparatus comprises a user equipment; and block 1310 includes receiving the one or more signals from the first network entity or a second network entity.

In one aspect, the apparatus comprises a second network entity; and block 1310 includes receiving the one or more signals from one or more user equipments.

In one aspect, method 1300 further includes receiving a second configuration of a plurality of signal attributes for receiving the plurality of signals, the plurality of signal attributes comprising at least a plurality of receive beams for receiving the plurality of signals.

In one aspect, method 1300 further includes obtaining at least one of: the codebook pattern; or a channel estimate for a channel associated with each of the one or more signals.

In one aspect, block 1315 includes determining the observation information associated with each of the one or more signals received at the apparatus based at least in part on the codebook pattern or the channel estimate for the channel associated with each of the one or more signals, and the observation information includes the one or more phase estimations.

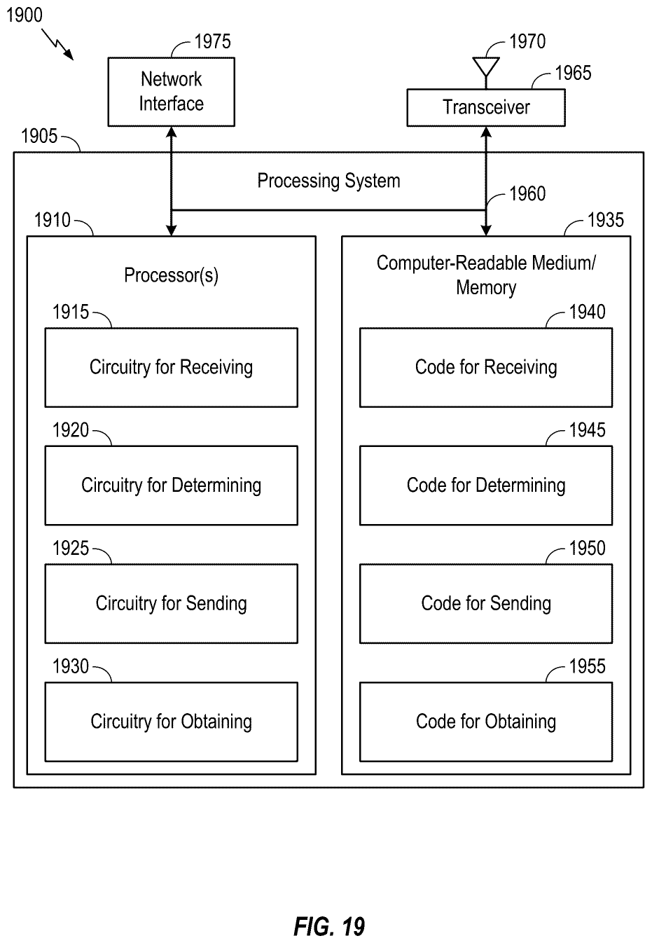

In one aspect, method 1300, or any aspect related to it, may be performed by an apparatus, such as communications device 1900 of FIG. 19, which includes various components operable, configured, or adapted to perform the method 1300. Communications device 1900 is described below in further detail.

Note that FIG. 13 is just one example of a method, and other methods including fewer, additional, or alternative operations are possible consistent with this disclosure.

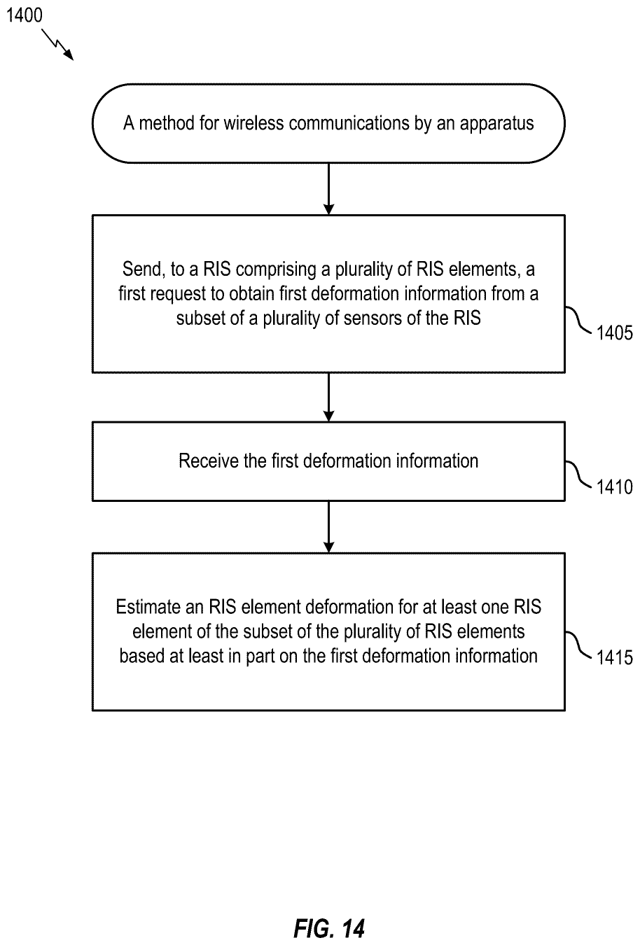

FIG. 14 shows a method 1400 for wireless communications by an apparatus, such as BS 102 of FIGS. 1 and 3, or a disaggregated base station as discussed with respect to FIG. 2.

Method 1400 begins at block 1405 with sending, to a RIS comprising a plurality of RIS elements, a first request to obtain first deformation information from a subset of a plurality of sensors of the RIS. In certain aspects, the first deformation information may be associated with a subset of the plurality of RIS elements.

Method 1400 then proceeds to block 1410 with receiving the first deformation information.

Method 1400 then proceeds to block 1415 with estimating an RIS element deformation for at least one RIS element of the subset of the plurality of RIS elements based at least in part on the first deformation information.

In certain aspects, method 1400 further includes determining a set of precoding weights based at least in part on the estimated RIS element deformation for the at least one RIS element.

In certain aspects, method 1400 further includes sending the set of precoding weights to the RIS.

In certain aspects, method 1400 further includes sending signaling configuring the RIS to download the set of precoding weights.

In certain aspects, method 1400 further includes receiving capability information of a capability of the RIS to obtain the first deformation information from the plurality of sensors of the RIS.

In certain aspects, method 1400 further includes receiving an indication of a time period when the RIS is capable of obtaining the first deformation information, and the first request to obtain the first deformation information is during the time period.

In one aspect, the first request further comprises an indication of a time period to obtain the first deformation information.

In certain aspects, method 1400 further includes receiving an indication that the RIS will proceed with obtaining the first deformation information during the time period based on the first request.

In certain aspects, method 1400 further includes sending, to the RIS, a second request to obtain second deformation information from the subset of the plurality of sensors during a time period, wherein the second deformation information is associated with the subset of the plurality of RIS elements.

In certain aspects, method 1400 further includes receiving an indication that the RIS will not obtain the second deformation information during the time period based on the second request.

In certain aspects, method 1400 further includes receiving an indication of one or more RIS element groups, each RIS element group including one or more of the plurality of RIS elements; and the subset of the plurality of RIS elements belongs to a first RIS element group of the one or more RIS element groups.

In one aspect, block 1415 includes estimating the RIS element deformation for the first RIS element group based at least in part on a single RIS element in the first RIS element group.

In certain aspects, method 1400 further includes receiving an indication of a plurality of RIS element groups, each RIS element group including one or more of the plurality of RIS elements, where the subset of the plurality of RIS elements belongs to two or more RIS element groups of the plurality of RIS element groups, and block 1415 includes estimating the RIS element deformation for the two or more RIS element groups based at least in part on a single RIS element in one of the two or more RIS element groups.

In one aspect, the subset of the plurality of RIS elements belongs to a plurality of RIS element groups including a first RIS element group and a second RIS element group; and block 1415 includes: estimating a first orientation change for the first RIS element group; estimating a second orientation change for the second RIS element group; and estimating a location change for the first RIS element group and not for the second RIS element group based at least in part on the estimated first orientation change and the estimated second orientation change.

In one aspect, the subset of the plurality of RIS elements are associated with a first sub-array of the RIS; and the RIS element deformation comprises an orientation change.

In certain aspects, method 1400 further includes sending signaling indicating to de-activate the RIS or the subset of the plurality of RIS elements based on the RIS element deformation.

In one aspect, the first deformation information comprises at least one of: measurements from the subset of the plurality of sensors; or the RIS element deformation for the at least one RIS element.

In one aspect, the RIS element deformation estimated for the at least one RIS element comprises at least one of: a location change; or an orientation change.

In certain aspects, method 1400 further includes receiving an indication of a degradation of the RIS; and block 1405 includes sending the first request based at least in part on receiving the indication.

In one aspect, method 1400, or any aspect related to it, may be performed by an apparatus, such as communications device 1800 of FIG. 18, which includes various components operable, configured, or adapted to perform the method 1400.

Communications device 1800 is described below in further detail.

Note that FIG. 14 is just one example of a method, and other methods including fewer, additional, or alternative operations are possible consistent with this disclosure.

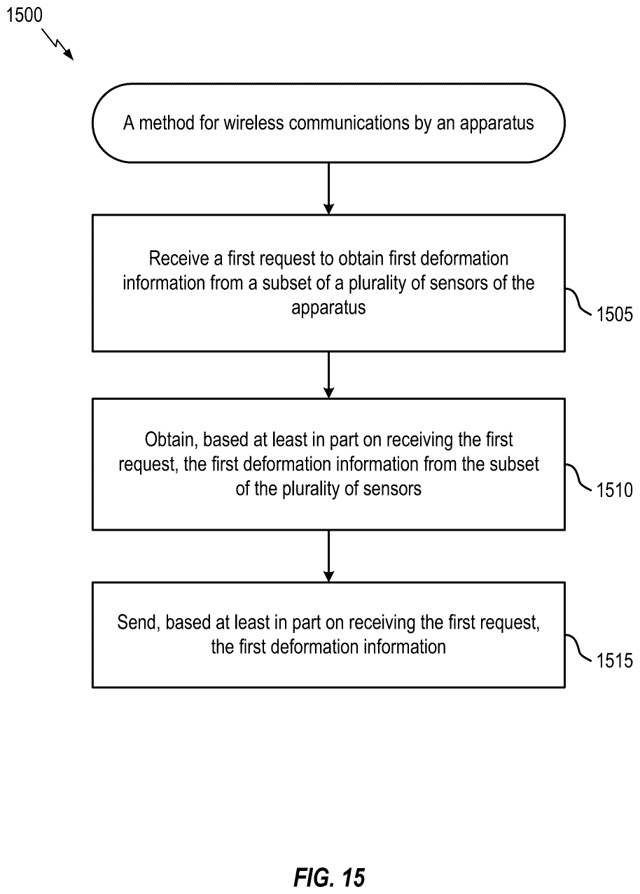

FIG. 15 shows a method 1500 of wireless communications by an apparatus, such as RIS, such as a combination of RIS 106 (e.g., the surface of RIS elements) and RIS controller 103 described above with respect to FIGS. 1 and 3. More specifically, method 1500 may be performed by the RIS controller of the RIS.

Method 1500 begins at block 1505 with receiving a first request to obtain first deformation information from a subset of a plurality of sensors of the apparatus. In certain aspects, the apparatus may comprise a plurality of RIS elements configured to modify signals between nodes, and the first deformation information is associated with a subset of the plurality of RIS elements.

Method 1500 then proceeds to block 1510 with obtaining, based at least in part on receiving the first request, the first deformation information from the subset of the plurality of sensors.

Method 1500 then proceeds to block 1515 with sending, based at least in part on receiving the first request, the first deformation information.

In one aspect, method 1500 further includes receiving a set of precoding weights.

In one aspect, method 1500 further includes updating a codebook pattern based at least in part on the set of precoding weights.

In one aspect, method 1500 further includes receiving signaling configuring the apparatus to download a set of precoding weights.

In one aspect, method 1500 further includes downloading the set of precoding weights.

In one aspect, method 1500 further includes updating a codebook pattern based at least in part on the set of precoding weights.

In one aspect, method 1500 further includes sending capability information of a capability of the apparatus to obtain the first deformation information from the plurality of sensors of the apparatus.

In one aspect, method 1500 further includes sending an indication of a time period when the apparatus is capable of obtaining the first deformation information, and the first request to obtain the first deformation information is during the time period.

In one aspect, the first request further comprises an indication of a time period to obtain the first deformation information.

In one aspect, method 1500 further includes sending an indication that the apparatus will proceed with obtaining the first deformation information during the time period based on the first request.

In one aspect, method 1500 further includes receiving a second request to obtain second deformation information from the subset of the plurality of sensors during a time period, wherein the second deformation information is associated with the subset of the plurality of RIS elements.

In one aspect, method 1500 further includes sending an indication that the apparatus will not obtain the second deformation information during the time period based on the second request.

In one aspect, method 1500 further includes estimating an RIS element deformation for at least one RIS element of the subset of the plurality of RIS elements based at least in part on the first deformation information.

In one aspect, method 1500 further includes sending an indication of one or more RIS element groups, each RIS element group including one or more of the plurality of RIS elements; and the subset of the plurality of RIS elements belongs to a first RIS element group of the one or more RIS element groups.

In one aspect, method 1500 further includes estimating an RIS element deformation for the first RIS element group based at least in part on a single RIS element in the first RIS element group.

In one aspect, the subset of the plurality of RIS elements belongs to two or more RIS element groups of a plurality of RIS element groups, and the method 1500 further comprises estimating an RIS element deformation for the two or more RIS element groups based at least in part on a single RIS element in one of the two or more RIS element groups.

In one aspect, the subset of the plurality of RIS elements belongs to a plurality of RIS element groups including a first RIS element group and a second RIS element group, the method 1500 further comprises estimating an RIS element deformation for at least one RIS element of the subset of the plurality of RIS elements, and estimating the RIS element deformation comprises: estimating a first orientation change for the first RIS element group; estimating a second orientation change for the second RIS element group; and estimating a location change for the first RIS element group and not for the second RIS element group based at least in part on the estimated first orientation change and the estimated second orientation change.

In one aspect, the subset of the plurality of RIS elements are associated with a first sub-array of the apparatus, and the method 1500 further comprises estimating an RIS element deformation for at least one RIS element of the subset of the plurality of RIS elements, where the RIS element deformation comprises an orientation change.

In one aspect, method 1500 further includes receiving signaling indicating to de-activate the apparatus or the subset of the plurality of RIS elements.

In one aspect, the first deformation information comprises at least one of: measurements from the subset of the plurality of sensors; or a RIS element deformation estimated for at least one RIS element of the subset of the plurality of RIS elements.

In one aspect, the RIS element deformation estimated for the at least one RIS element comprises at least one of: a location change; or an orientation change.

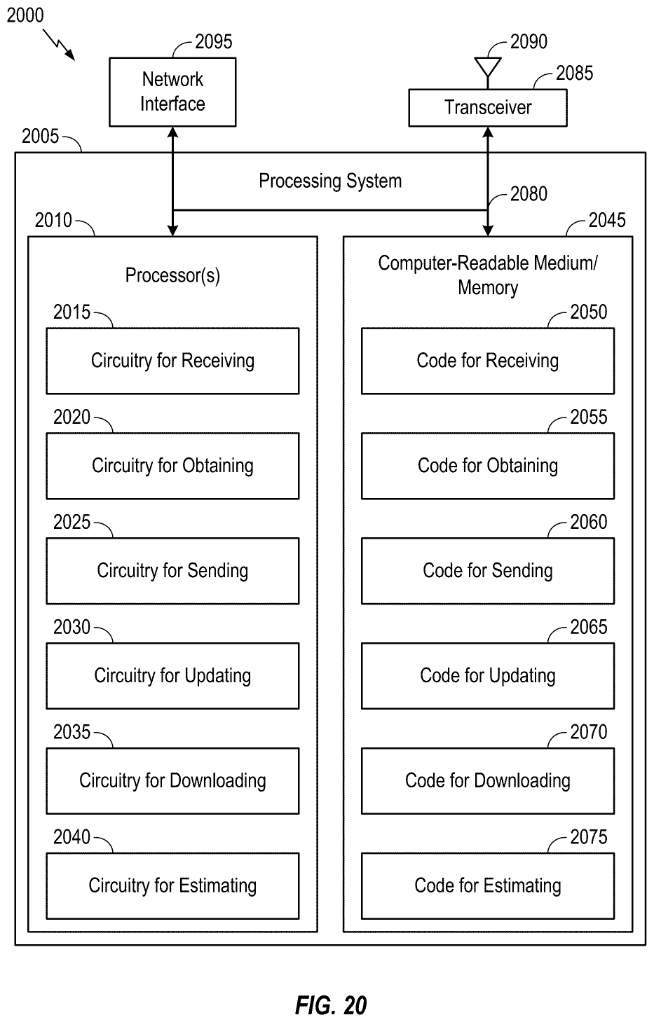

In one aspect, method 1500, or any aspect related to it, may be performed by an apparatus, such as communications device 2000 of FIG. 20, which includes various components operable, configured, or adapted to perform the method 1500. Communications device 2000 is described below in further detail.

Note that FIG. 15 is just one example of a method, and other methods including fewer, additional, or alternative operations are possible consistent with this disclosure.

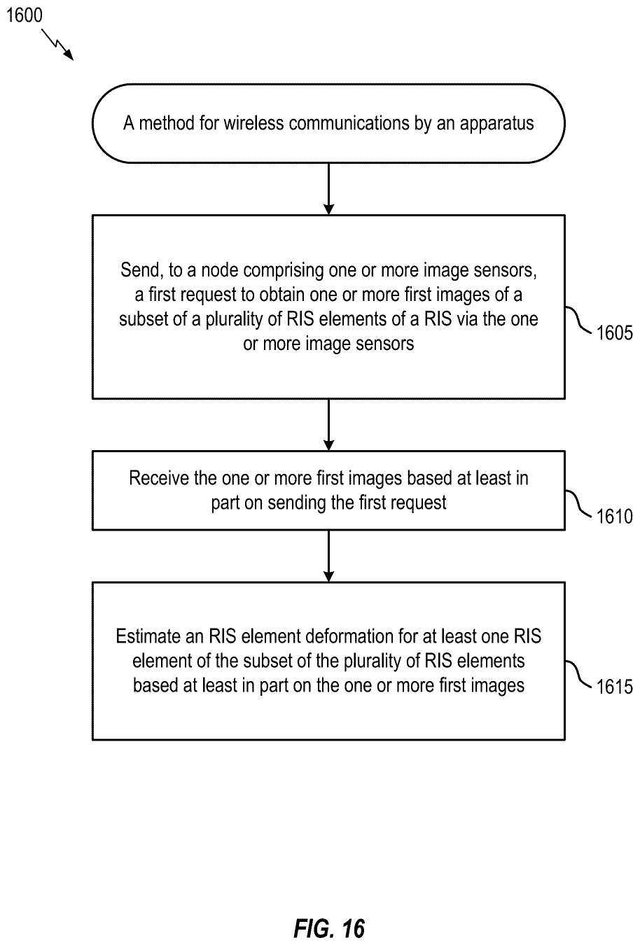

FIG. 16 shows a method 1600 for wireless communications by an apparatus, such as BS 102 of FIGS. 1 and 3, or a disaggregated base station as discussed with respect to FIG. 2.

Method 1600 begins at block 1605 with sending, to a node comprising one or more image sensors, a first request to obtain one or more first images of a subset of a plurality of RIS elements of a RIS via the one or more image sensors.

Method 1600 then proceeds to block 1610 with receiving the one or more first images based at least in part on sending the first request.

Method 1600 then proceeds to block 1615 with estimating an RIS element deformation for at least one RIS element of the subset of the plurality of RIS elements based at least in part on the one or more first images.

In certain aspects, method 1600 further includes determining a set of precoding weights based at least in part on the estimated RIS element deformation for the at least one RIS element.

In certain aspects, method 1600 further includes sending the set of precoding weights to the RIS.

In certain aspects, method 1600 further includes receiving capability information of a capability of the node to obtain images of the RIS via the one or more image sensors of the node.

In certain aspects, method 1600 further includes sending feature information for one or more features of the RIS.

In one aspect, the first request further comprises an indication of a time period to obtain the one or more first images.

In certain aspects, method 1600 further includes receiving an indication that the node will proceed with obtaining the one or more first images during the time period based on the first request.

In certain aspects, method 1600 further includes sending, to the node, a second request to obtain one or more second images of the subset of the plurality of RIS elements of the RIS via the one or more image sensors during a time period.

In certain aspects, method 1600 further includes receiving an indication that the node will not obtain the one or more second images during the time period based on the second request.

In one aspect, block 1610 includes receiving an image reading matrix associated with the one or more first images.

In one aspect, the RIS element deformation estimated for the at least one RIS element comprises at least one of: a location change; or an orientation change.

In certain aspects, method 1600 further includes receiving an indication of a degradation of the RIS, and block 1605 includes sending the first request based on receiving the indication.

In one aspect, method 1600, or any aspect related to it, may be performed by an apparatus, such as communications device 1800 of FIG. 18, which includes various components operable, configured, or adapted to perform the method 1600. Communications device 1800 is described below in further detail.

Note that FIG. 16 is just one example of a method, and other methods including fewer, additional, or alternative operations are possible consistent with this disclosure.

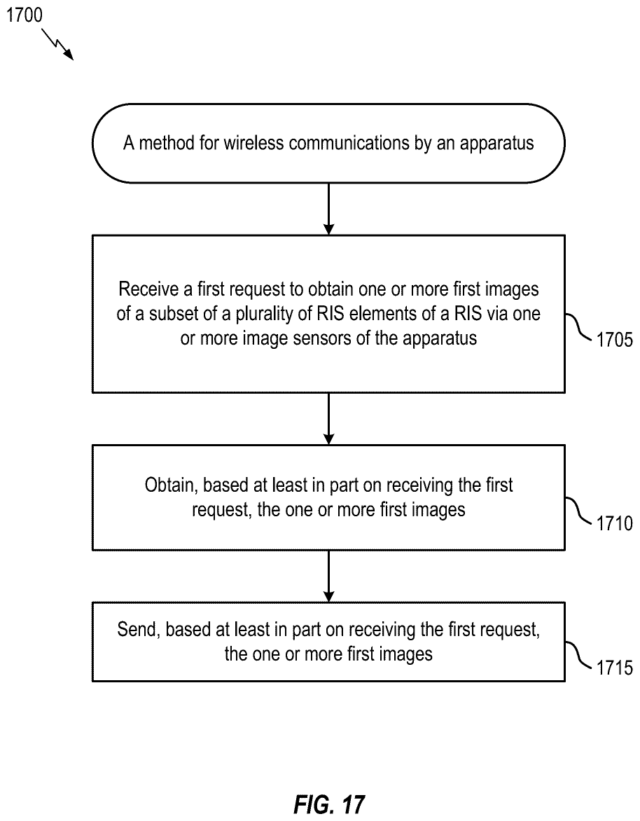

FIG. 17 shows a method 1700 of wireless communications by an apparatus, such as UE 104 of FIGS. 1 and 3, BS 102 of FIGS. 1 and 3, or a disaggregated base station discussed with respect to FIG. 2.

Method 1700 begins at block 1705 with receiving a first request to obtain one or more first images of a subset of a plurality of RIS elements of a RIS via one or more image sensors of the apparatus.

Method 1700 then proceeds to block 1710 with obtaining, based at least in part on receiving the first request, the one or more first images.

Method 1700 then proceeds to block 1715 with sending, based at least in part on receiving the first request, the one or more first images.

In one aspect, method 1700 further includes sending capability information of a capability of the apparatus to obtain images of the RIS via the one or more image sensors.

In one aspect, method 1700 further includes receiving feature information for one or more features of the RIS, and block 1710 includes obtaining the one or more first images based at least in part on the feature information.

In one aspect, the first request further comprises an indication of a time period to obtain the one or more first images.

In one aspect, method 1700 further includes sending an indication that the apparatus will proceed with obtaining the one or more first images during the time period based on the first request.

In one aspect, method 1700 further includes receiving a second request to obtain one or more second images of the subset of the plurality of RIS elements of the RIS via the one or more image sensors during a time period.

In one aspect, method 1700 further includes sending an indication that the apparatus will not obtain the one or more second images during the time period based at least in part on the second request.

In one aspect, block 1715 includes sending an image reading matrix associated with the one or more first images.

In one aspect, method 1700, or any aspect related to it, may be performed by an apparatus, such as communications device 1900 of FIG. 19, which includes various components operable, configured, or adapted to perform the method 1700. Communications device 1900 is described below in further detail.

Note that FIG. 17 is just one example of a method, and other methods including fewer, additional, or alternative operations are possible consistent with this disclosure.

### Example Communications Devices

FIG. 18 depicts aspects of an example communications device 1800. In some aspects, communications device 1800 is a network entity, such as BS 102 of FIGS. 1 and 3, or a disaggregated base station as discussed with respect to FIG. 2.

The communications device 1800 includes a processing system 1805 coupled to a transceiver 1885 (e.g., a transmitter and/or a receiver) and/or a network interface 1895. The transceiver 1885 is configured to transmit and receive signals for the communications device 1800 via an antenna 1890, such as the various signals as described herein. The network interface 1895 is configured to obtain and send signals for the communications device 1800 via communications link(s), such as a backhaul link, midhaul link, and/or fronthaul link as described herein, such as with respect to FIG. 2. The processing system 1805 may be configured to perform processing functions for the communications device 1800, including processing signals received and/or to be transmitted by the communications device 1800.

The processing system 1805 includes one or more processors 1810. In various aspects, one or more processors 1810 may be representative of one or more of receive processor 338, transmit processor 320, TX MIMO processor 330, and/or controller/processor 340, as described with respect to FIG. 3. The one or more processors 1810 are coupled to a computer-readable medium/memory 1845 via a bus 1880. In certain aspects, the computer-readable medium/memory 1845 is configured to store instructions (e.g., computer-executable code), including code 1850-1875, that when executed by the one or more processors 1810, enable and cause the one or more processors 1810 to perform the method 1200 described with respect to FIG. 12, or any aspect related to it, including any operations described in relation to FIG. 12; the method 1400 described with respect to FIG. 14, or any aspect related to it, including any operations described in relation to FIG. 14; and the method 1600 described with respect to FIG. 16, or any aspect related to it, including any operations described in relation to FIG. 16. Note that reference to a processor of communications device 1800 performing a function may include one or more processors of communications device 1800 performing that function, such as in a distributed fashion.

In the depicted example, the computer-readable medium/memory 1845 stores code for configuring 1850, code for obtaining 1855, code for estimating 1860, code for receiving 1865, code for determining 1870, and code for sending 1875. Processing of the code 1850-1875 may enable and cause the communications device 1800 to perform the method 1200 described with respect to FIG. 12, or any aspect related to it; the method 1400 described with respect to FIG. 14, or any aspect related to it; and the method 1600 described with respect to FIG. 16, or any aspect related to it.

The one or more processors 1810 include circuitry configured to implement (e.g., execute) the code (e.g., executable instructions) stored in the computer-readable medium/memory 1845, including circuitry for configuring 1815, circuitry for obtaining 1820, circuitry for estimating 1825, circuitry for receiving 1830, circuitry for determining 1835, and circuitry for sending 1840. Processing with circuitry 1815-1840 may enable and cause the communications device 1800 to perform the method 1200 described with respect to FIG. 12, or any aspect related to it; the method 1400 described with respect to FIG. 14, or any aspect related to it; and the method 1600 described with respect to FIG. 16, or any aspect related to it.

Various components of the communications device 1800 may provide means for performing the method 1200 described with respect to FIG. 12, or any aspect related to it; the method 1400 described with respect to FIG. 14, or any aspect related to it; and the method 1600 described with respect to FIG. 16, or any aspect related to it. Means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1885, antenna 1890, and/or network interface 1895 of the communications device 1800 in FIG. 18, and/or one or more processors 1810 of the communications device 1800 in FIG. 18. Means for communicating, receiving or obtaining may include the transceivers 332, antenna(s) 334, receive processor 338, AI processor 318, and/or controller/processor 340 of the BS 102 illustrated in FIG. 3, transceiver 1885, antenna 1890, and/or network interface 1895 of the communications device 1800 in FIG. 18, and/or one or more processors 1810 of the communications device 1800 in FIG. 18. Further, means for configuring, estimating, and/or determining of the method 1200 described with respect to FIG. 12, or any aspect related to it; the method 1400 described with respect to FIG. 14, or any aspect related to it; and the method 1600 described with respect to FIG. 16, or any aspect related to it, may include controller/processor 340 of the BS 102 illustrated in FIG. 3 and/or one or more processors 1810 of the communications device 1800 in FIG. 18.

FIG. 19 depicts aspects of an example communications device 1900. In some aspects, communications device 1900 is a user equipment, such as UE 104 described above with respect to FIGS. 1 and 3. In some aspects, communications device 1900 is a network entity, such as BS 102 of FIGS. 1 and 3, or a disaggregated base station as discussed with respect to FIG. 2.

The communications device 1900 includes a processing system 1905 coupled to a transceiver 1965 (e.g., a transmitter and/or a receiver) and/or a network interface 1975. The transceiver 1965 is configured to transmit and receive signals for the communications device 1900 via an antenna 1970, such as the various signals as described herein. The network interface 1975 is configured to obtain and send signals for the communications device 1900 via communications link(s), such as a backhaul link, midhaul link, and/or fronthaul link as described herein, such as with respect to FIG. 2. The processing system 1905 may be configured to perform processing functions for the communications device 1900, including processing signals received and/or to be transmitted by the communications device 1900.

The processing system 1905 includes one or more processors 1910. In various aspects, the one or more processors 1910 may be representative of one or more of receive processor 338, receive processor 358, transmit processor 320, transmit processor 364, TX MIMO processor 330, TX MIMO processor 366, controller/processor 340, and/or controller/processor 380, as described with respect to FIG. 3. The one or more processors 1910 are coupled to a computer-readable medium/memory 1935 via a bus 1960. In certain aspects, the computer-readable medium/memory 1935 is configured to store instructions (e.g., computer-executable code), including code 1940-1955, that when executed by the one or more processors 1910, enable and cause the one or more processors 1910 to perform the method 1300 described with respect to FIG. 13, or any aspect related to it, including any operations described in relation to FIG. 13; and the method 1700 described with respect to FIG. 17, or any aspect related to it, including any operations described in relation to FIG. 17. Note that reference to a processor performing a function of communications device 1900 may include one or more processors performing that function of communications device 1900, such as in a distributed fashion.

In the depicted example, computer-readable medium/memory 1935 stores code for receiving 1940, code for determining 1945, code for sending 1950, and code for obtaining 1955. Processing of the code 1940-1955 may enable and cause the communications device 1900 to perform the method 1300 described with respect to FIG. 13, or any aspect related to it; and the method 1700 described with respect to FIG. 17, or any aspect related to it.

The one or more processors 1910 include circuitry configured to implement (e.g., execute) the code (e.g., executable instructions) stored in the computer-readable medium/memory 1935, including circuitry for receiving 1915, circuitry for determining 1920, circuitry for sending 1925, and circuitry for obtaining 1930. Processing with circuitry 1915-1930 may enable and cause the communications device 1900 to perform the method 1300 described with respect to FIG. 13, or any aspect related to it; and the method 1700 described with respect to FIG. 17, or any aspect related to it.

Various components of the communications device 1900 may provide means for performing the method 1300 described with respect to FIG. 13, or any aspect related to it; and the method 1700 described with respect to FIG. 17, or any aspect related to it. Means for communicating, transmitting, sending or outputting for transmission may include: the transceivers 332, antenna(s) 334, transmit processor 320, TX MIMO processor 330, AI processor 318, and/or controller/processor 340 of the BS 102 illustrated in FIG. 3; the transceivers 354, antenna(s) 352, transmit processor 364, TX MIMO processor 366, AI processor 370, and/or controller/processor 380 of the UE 104 illustrated in FIG. 3; transceiver 1965, antenna 1970, and/or network interface 1975 of the communications device 1900 in FIG. 19; and/or one or more processors 1910 of the communications device 1900 in FIG. 19. Means for communicating, receiving or obtaining may include: the transceivers 332, antenna(s) 334, receive processor 338, AI processor 318, and/or controller/processor 340 of the BS 102 illustrated in FIG. 3; the transceivers 354, antenna(s) 352, receive processor 358, AI processor 370, and/or controller/processor 380 of the UE 104 illustrated in FIG. 3; transceiver 1965, antenna 1970, and/or network interface 1975 of the communications device 1900 in FIG. 19; and/or one or more processors 1904 of the communications device 1900 in FIG. 19. Further, means for determining of the method 1300 described with respect to FIG. 13, or any aspect related to it; and the method 1700 described with respect to FIG. 17, or any aspect related to it, may include controller/processor 340 of the BS 102 illustrated in FIG. 3, controller/processor 380 of the UE 104 illustrated in FIG. 3, and/or one or more processors 1910 of the communications device 1900 in FIG. 19.

FIG. 20 depicts aspects of an example communications device 2000. In some aspects, communications device 2000 is a RIS, such as a combination of RIS 106 (e.g., the surface of RIS elements) and RIS controller 103 described above with respect to FIGS. 1 and 3.

The communications device 2000 includes a processing system 2005 coupled to a transceiver 2085 (e.g., a transmitter and/or a receiver) and/or a network interface 2095. The transceiver 2085 is configured to transmit and receive signals for the communications device 2000 via an antenna 2090, such as the various signals as described herein. The network interface 2095 is configured to obtain and send signals for the communications device 2000. The processing system 2005 may be configured to perform processing functions for the communications device 2000, including processing signals received and/or to be transmitted by the communications device 2000.

The processing system 2005 includes one or more processors 2010. The one or more processors 2010 are coupled to a computer-readable medium/memory 2045 via a bus 2080. In certain aspects, the computer-readable medium/memory 2045 is configured to store instructions (e.g., computer-executable code), including code 2050-2075, that when executed by the one or more processors 2010, enable and cause the one or more processors 2010 to perform the method 1500 described with respect to FIG. 15, or any aspect related to it, including any operations described in relation to FIG. 15. Note that reference to a processor performing a function of communications device 2000 may include one or more processors performing that function of communications device 2000, such as in a distributed fashion.

In the depicted example, computer-readable medium/memory 2045 stores code for receiving 2050, code for obtaining 2055, code for sending 2060, code for updating 2065, code for downloading 2070, and code for estimating 2075. Processing of the code 2050-2075 may enable and cause the communications device 2000 to perform the method 1500 described with respect to FIG. 15, or any aspect related to it.

The one or more processors 2010 include circuitry configured to implement (e.g., execute) the code (e.g., executable instructions) stored in the computer-readable medium/memory 2045, including circuitry for receiving 2015, circuitry for obtaining 2020, circuitry for sending 2025, circuitry for updating 2030, circuitry for downloading 2035, and circuitry for estimating 2040. Processing with circuitry 2015-2040 may enable and cause the communications device 2000 to perform the method 1500 described with respect to FIG. 15, or any aspect related to it.

Various components of the communications device 2000 may provide means for performing the method 1500 described with respect to FIG. 15, or any aspect related to it. Means for communicating, transmitting, sending or outputting for transmission may include: transceiver 2085, antenna 2090, and/or network interface 2095 of the communications device 2000 in FIG. 20; and/or one or more processors 2010 of the communications device 2000 in FIG. 20. Means for communicating, receiving or obtaining may include: transceiver 2085, antenna 2090, and/or network interface 2095 of the communications device 2000 in FIG. 20 and/or one or more processors 2004 of the communications device 2000 in FIG. 20. Further, means for updating, downloading, and/or estimating of the method 1500 described with respect to FIG. 15, or any aspect related to it, may include one or more processors 2010 of the communications device 2000 in FIG. 20.

As described herein, a RIS, such as example communications device 2000, may be used to modify (or shape) radio signal(s), from a transmitter, towards a receiver. Various components of the communications device 2000 may be used to perform such functionality; however, it is noted, that the radio signal(s) intended for the receiver (e.g., assisted via communications device 2000) may not be decoded by the communications device 2000.

### EXAMPLE CLAUSES

Implementation examples are described in the following numbered clauses:
Clause 1: A method for wireless communications by an apparatus comprising: configuring a plurality of nodes with a plurality of time-frequency resources for communicating a plurality of signals with the apparatus or a network entity via a RIS comprising a plurality of RIS elements; obtaining observation information associated with the plurality of signals communicated between the plurality of nodes and the apparatus or the network entity via the RIS; determining an RIS element deformation for at least one RIS element of the plurality of RIS elements based at least in part on the observation information and a deformation database associated with the RIS, the deformation database providing a mapping between a plurality of RIS element deformations and one or more observations expected for each of the plurality of RIS element deformations; and sending, to at least one of the RIS or the network entity, a codebook pattern update to compensate for the RIS element deformation for the at least one RIS element.
Clause 2: The method of Clause 1, wherein the observation information associated with the plurality of signals comprises at least one of: one or more in-phase and quadrature (IQ) samples; one or more reference signal received power (RSRP) measurements; or one or more phase estimations.
Clause 3: The method of any one of Clauses 1-2, wherein sending the codebook pattern update comprises: determining a set of precoding weights based at least in part on the RIS element deformation for the at least one RIS element of the plurality of RIS elements; and sending, to the at least one of the RIS or the network entity, the set of precoding weights.
Clause 4: The method of any one of Clauses 1-3, wherein: configuring the plurality of nodes comprises configuring the plurality of nodes with the plurality of time-frequency resources for transmitting the plurality of signals to the network entity via the RIS; and obtaining the observation information comprises obtaining the observation information from the network entity.
Clause 5: The method of any one of Clauses 1-4, wherein: configuring the plurality of nodes comprises configuring the plurality of nodes with the plurality of time-frequency resources for receiving the plurality of signals from the apparatus or the network entity via the RIS; and obtaining the observation information comprises obtaining the observation information from the plurality of nodes.
Clause 6: The method of Clause 5, further comprising sending the plurality of signals to the plurality of nodes via the RIS.
Clause 7: The method of any one of Clauses 1-6, wherein: configuring the plurality of nodes comprises configuring the plurality of nodes with the plurality of time-frequency resources for transmitting the plurality of signals to the apparatus via the RIS; and obtaining the observation information comprises determining the observation information based on the plurality of signals.
Clause 8: The method of any one of Clauses 1-7, further comprising configuring the plurality of nodes with a plurality of signal attributes for communicating the plurality of signals, the plurality of signal attributes comprising at least a plurality of transmit beams or a plurality of receive beams for communicating the plurality of signals.
Clause 9: The method of any one of Clauses 1-8, wherein the observation information associated with the plurality of signals comprises at least one of: one or more IQ samples; one or more RSRP; or one or more phase estimations.
Clause 10: The method of any one of Clauses 1-9, wherein the plurality of RIS element deformations included in the deformation database comprise one or more of: a plurality of RIS element bend types; a plurality of RIS element bend angles; a plurality of RIS element tilt types; a plurality of RIS element tilt angles; or a plurality of RIS element translations.
Clause 11: The method of any one of Clauses 1-10, wherein the RIS element deformation determined for the at least one RIS element comprises at least one of: a location change; or an orientation change.
Clause 12: The method of any one of Clauses 1-11, further comprising receiving an indication of a degradation of the RIS; and configuring the plurality of nodes comprises configuring the plurality of nodes based on receiving the indication.
Clause 13: A method for wireless communications by an apparatus comprising: receiving a first configuration of a plurality of time-frequency resources for receiving a plurality of signals via a RIS comprising a plurality of RIS elements; receiving, via one or more of the plurality of time-frequency resources, one or more signals of the plurality of signals via the RIS; determining observation information associated with the one or more signals received at the apparatus, wherein the observation information comprises at least one of: one or more in-phase and quadrature (IQ) samples; one or more reference signal received power (RSRP) measurements; or one or more phase estimations; and sending the observation information to a first network entity.
Clause 14: The method of Clause 13, wherein: the apparatus comprises a user equipment; and receiving the one or more signals comprises receiving the one or more signals from the first network entity or a second network entity.
Clause 15: The method of any one of Clauses 13-14, wherein: the apparatus comprises a second network entity; and receiving the one or more signals comprises receiving the one or more signals from one or more user equipments.
Clause 16: The method of any one of Clauses 13-15, further comprising receiving a second configuration of a plurality of signal attributes for receiving the plurality of signals, the plurality of signal attributes comprising at least a plurality of receive beams for receiving the plurality of signals.
Clause 17: The method of any one of Clauses 13-16, further comprising obtaining at least one of: the codebook pattern; or a channel estimate for a channel associated with each of the one or more signals.
Clause 18: The method of Clause 17, wherein: determining the observation information comprises determining the observation information associated with each of the one or more signals received at the apparatus based at least in part on the codebook pattern or the channel estimate for the channel associated with each of the one or more signals, and the observation information comprises the one or more phase estimations.
Clause 19: The method of any one of Clauses 13-18, wherein the observation information associated with the plurality of signals comprises at least one of: one or more IQ samples; one or more RSRP; or one or more phase estimations.
Clause 20: A method for wireless communications by an apparatus comprising: sending, to a RIS comprising a plurality of RIS elements, a first request to obtain first deformation information from a subset of a plurality of sensors of the RIS, wherein the first deformation information is associated with a subset of the plurality of RIS elements; receiving the first deformation information; and estimating an RIS element deformation for at least one RIS element of the subset of the plurality of RIS elements based at least in part on the first deformation information.
Clause 21: The method of Clause 20, further comprising determining a set of precoding weights based at least in part on the estimated RIS element deformation for the at least one RIS element.
Clause 22: The method of Clause 21, further comprising sending the set of precoding weights to the RIS.
Clause 23: The method of Clause 21, further comprising sending signaling configuring the RIS to download the set of precoding weights.
Clause 24: The method of any one of Clauses 20-23, further comprising receiving capability information of a capability of the RIS to obtain the first deformation information from the plurality of sensors of the RIS.
Clause 25: The method of Clause 24, further comprising receiving an indication of a time period when the RIS is capable of obtaining the first deformation information, and the first request to obtain the first deformation information is during the time period.
Clause 26: The method of any one of Clauses 20-25, wherein the first request further comprises an indication of a time period to obtain the first deformation information.
Clause 27: The method of Clause 26, further comprising receiving an indication that the RIS will proceed with obtaining the first deformation information during the time period based on the first request.
Clause 28: The method of any one of Clauses 20-27, further comprising: sending, to the RIS, a second request to obtain second deformation information from the subset of the plurality of sensors during a time period, wherein the second deformation information is associated with the subset of the plurality of RIS elements; and receiving an indication that the RIS will not obtain the second deformation information during the time period based on the second request.
Clause 29: The method of any one of Clauses 20-28, further comprising receiving an indication of one or more RIS element groups, each RIS element group including one or more of the plurality of RIS elements; and the subset of the plurality of RIS elements belongs to a first RIS element group of the one or more RIS element groups.
Clause 30: The method of Clause 29, wherein estimating the RIS element deformation for the at least one RIS element of the subset of the plurality of RIS elements comprises estimating the RIS element deformation for the first RIS element group based at least in part on a single RIS element in the first RIS element group.
Clause 31: The method of any one of Clauses 20-30, further comprising receiving an indication of a plurality of RIS element groups, each RIS element group including one or more of the plurality of RIS elements, where the subset of the plurality of RIS elements belongs to two or more RIS element groups of the plurality of RIS element groups, and estimating the RIS element deformation for the at least one RIS element of the subset of the plurality of RIS elements comprises estimating the RIS element deformation for the two or more RIS element groups based at least in part on a single RIS element in one of the two or more RIS element groups.
Clause 32: The method of any one of Clauses 20-31, wherein: the subset of the plurality of RIS elements belongs to a plurality of RIS element groups including a first RIS element group and a second RIS element group; and estimating the RIS element deformation for the at least one RIS element of the subset of the plurality of RIS elements comprises: estimating a first orientation change for the first RIS element group; estimating a second orientation change for the second RIS element group; and estimating a location change for the first RIS element group and not for the second RIS element group based at least in part on the estimated first orientation change and the estimated second orientation change.
Clause 33: The method of any one of Clauses 20-32, wherein: the subset of the plurality of RIS elements are associated with a first sub-array of the RIS; and the RIS element deformation comprises an orientation change.
Clause 34: The method of any one of Clauses 20-33, further comprising: sending signaling indicating to de-activate the RIS or the subset of the plurality of RIS elements based on the RIS element deformation.
Clause 35: The method of any one of Clauses 20-34, wherein the first deformation information comprises at least one of: measurements from the subset of the plurality of sensors; or the RIS element deformation for the at least one RIS element.
Clause 36: The method of any one of Clauses 20-35, wherein the RIS element deformation estimated for the at least one RIS element comprises at least one of: a location change; or an orientation change.
Clause 37: The method of any one of Clauses 20-36, further comprising receiving an indication of a degradation of the RIS; and sending the first request comprises sending the first request based at least in part on receiving the indication.
Clause 38: A method for wireless communications by an apparatus comprising: receiving a first request to obtain first deformation information from a subset of a plurality of sensors of the apparatus, wherein: the apparatus comprises a plurality of RIS elements configured to modify signals between nodes, and the first deformation information is associated with a subset of the plurality of RIS elements; and based at least in part on receiving the first request: obtaining the first deformation information from the subset of the plurality of sensors; and sending the first deformation information.
Clause 39: The method of Clause 38, further comprising: receiving a set of precoding weights; and updating a codebook pattern based at least in part on the set of precoding weights.
Clause 40: The method of any one of Clauses 38-39, further comprising: receiving signaling configuring the apparatus to download a set of precoding weights; downloading the set of precoding weights; and updating a codebook pattern based at least in part on the set of precoding weights.
Clause 41: The method of any one of Clauses 38-40, further comprising sending capability information of a capability of the apparatus to obtain the first deformation information from the plurality of sensors of the apparatus.
Clause 42: The method of Clause 41, further comprising sending an indication of a time period when the apparatus is capable of obtaining the first deformation information, and the first request to obtain the first deformation information is during the time period.
Clause 43: The method of any one of Clauses 38-42, wherein the first request further comprises an indication of a time period to obtain the first deformation information.
Clause 44: The method of Clause 43, further comprising sending an indication that the apparatus will proceed with obtaining the first deformation information during the time period based on the first request.
Clause 45: The method of any one of Clauses 38-44, further comprising: receiving a second request to obtain second deformation information from the subset of the plurality of sensors during a time period, wherein the second deformation information is associated with the subset of the plurality of RIS elements; and sending an indication that the apparatus will not obtain the second deformation information during the time period based on the second request.
Clause 46: The method of any one of Clauses 38-45, further comprising: estimating an RIS element deformation for at least one RIS element of the subset of the plurality of RIS elements based at least in part on the first deformation information.
Clause 47: The method of any one of Clauses 38-46, further comprising sending an indication of one or more RIS element groups, each RIS element group including one or more of the plurality of RIS elements; and the subset of the plurality of RIS elements belongs to a first RIS element group of the one or more RIS element groups.
Clause 48: The method of Clause 47, further comprising estimating an RIS element deformation for the first RIS element group based at least in part on a single RIS element in the first RIS element group.
Clause 49: The method of any one of Clauses 38-48, wherein: the subset of the plurality of RIS elements belongs to two or more RIS element groups of a plurality of RIS element groups, and the method further comprises estimating an RIS element deformation for the two or more RIS element groups based at least in part on a single RIS element in one of the two or more RIS element groups.
Clause 50: The method of any one of Clauses 38-49, wherein: the subset of the plurality of RIS elements belongs to a plurality of RIS element groups including a first RIS element group and a second RIS element group, the method further comprises estimating an RIS element deformation for at least one RIS element of the subset of the plurality of RIS elements, and estimating the RIS element deformation comprises: estimating a first orientation change for the first RIS element group; estimating a second orientation change for the second RIS element group; and estimating a location change for the first RIS element group and not for the second RIS element group based at least in part on the estimated first orientation change and the estimated second orientation change.
Clause 51: The method of any one of Clauses 38-50, wherein: the subset of the plurality of RIS elements are associated with a first sub-array of the apparatus, and the method further comprises estimating an RIS element deformation for at least one RIS element of the subset of the plurality of RIS elements, where the RIS element deformation comprises an orientation change.
Clause 52: The method of any one of Clauses 38-51, further comprising: receiving signaling indicating to de-activate the apparatus or the subset of the plurality of RIS elements.
Clause 53: The method of any one of Clauses 38-52, wherein the first deformation information comprises at least one of: measurements from the subset of the plurality of sensors; or a RIS element deformation estimated for at least one RIS element of the subset of the plurality of RIS elements.
Clause 54: The method of Clause 53, wherein the RIS element deformation estimated for the at least one RIS element comprises at least one of: a location change; or an orientation change.
Clause 55: A method for wireless communications by an apparatus comprising: sending, to a node comprising one or more image sensors, a first request to obtain one or more first images of a subset of a plurality of RIS elements of a RIS via the one or more image sensors; receiving the one or more first images based at least in part on sending the first request; and estimating an RIS element deformation for at least one RIS element of the subset of the plurality of RIS elements based at least in part on the one or more first images.
Clause 56: The method of Clause 55, further comprising determining a set of precoding weights based at least in part on the estimated RIS element deformation for the at least one RIS element.
Clause 57: The method of Clause 56, further comprising sending the set of precoding weights to the RIS.
Clause 58: The method of any one of Clauses 55-57, further comprising receiving capability information of a capability of the node to obtain images of the RIS via the one or more image sensors of the node.
Clause 59: The method of any one of Clauses 55-58, further comprising sending feature information for one or more features of the RIS.
Clause 60: The method of any one of Clauses 55-59, wherein the first request further comprises an indication of a time period to obtain the one or more first images.
Clause 61: The method of Clause 60, further comprising receiving an indication that the node will proceed with obtaining the one or more first images during the time period based on the first request.
Clause 62: The method of any one of Clauses 55-61, further comprising: sending, to the node, a second request to obtain one or more second images of the subset of the plurality of RIS elements of the RIS via the one or more image sensors during a time period; and receiving an indication that the node will not obtain the one or more second images during the time period based on the second request.
Clause 63: The method of any one of Clauses 55-62, wherein receiving the one or more first images comprises receiving an image reading matrix associated with the one or more first images.
Clause 64: The method of any one of Clauses 55-63, wherein the RIS element deformation estimated for the at least one RIS element comprises at least one of: a location change; or an orientation change.
Clause 65: The method of any one of Clauses 55-64, further comprising receiving an indication of a degradation of the RIS, and sending the first request comprises sending the first request based on receiving the indication.
Clause 66: A method for wireless communications by an apparatus comprising: receiving a first request to obtain one or more first images of a subset of a plurality of RIS elements of a RIS via one or more image sensors of the apparatus; and based at least in part on receiving the first request: obtaining the one or more first images; and sending the one or more first images.
Clause 67: The method of Clause 66, further comprising: sending capability information of a capability of the apparatus to obtain images of the RIS via the one or more image sensors.
Clause 68: The method of any one of Clauses 66-67, further comprising receiving feature information for one or more features of the RIS, and obtaining the one or more first images comprises obtaining the one or more first images based at least in part on the feature information.
Clause 69: The method of any one of Clauses 66-68, wherein the first request further comprises an indication of a time period to obtain the one or more first images.
Clause 70: The method of Clause 69, further comprising sending an indication that the apparatus will proceed with obtaining the one or more first images during the time period based on the first request.
Clause 71: The method of any one of Clauses 66-70, further comprising: receiving a second request to obtain one or more second images of the subset of the plurality of RIS elements of the RIS via the one or more image sensors during a time period; and sending an indication that the apparatus will not obtain the one or more second images during the time period based at least in part on the second request.
Clause 72: The method of any one of Clauses 66-71, wherein sending the one or more first images comprises sending an image reading matrix associated with the one or more first images.
Clause 73: One or more apparatuses, comprising: one or more memories comprising executable instructions; and one or more processors configured to execute the executable instructions and cause the one or more apparatuses to perform a method in accordance with any one of Clauses 1-72.
Clause 74: One or more apparatuses, comprising: one or more memories; and one or more processors, coupled to the one or more memories, configured to cause the one or more apparatuses to perform a method in accordance with any one of Clauses 1-72.
Clause 75: One or more apparatuses, comprising: one or more memories; and one or more processors, coupled to the one or more memories, configured to perform a method in accordance with any one of Clauses 1-72.
Clause 76: One or more apparatuses, comprising means for performing a method in accordance with any one of Clauses 1-72.
Clause 77: One or more non-transitory computer-readable media comprising executable instructions that, when executed by one or more processors of one or more apparatuses, cause the one or more apparatuses to perform a method in accordance with any one of Clauses 1-72.
Clause 78: One or more computer program products embodied on one or more computer-readable storage media comprising code for performing a method in accordance with any one of Clauses 1-72.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
configure a plurality of nodes with a plurality of time-frequency resources for communicating a plurality of signals with the apparatus or a network entity via a reconfigurable intelligent surface (RIS) comprising a plurality of RIS elements;
obtain observation information associated with the plurality of signals communicated between the plurality of nodes and the apparatus or the network entity via the RIS;
determine an RIS element deformation for at least one RIS element of the plurality of RIS elements based at least in part on the observation information and a deformation database associated with the RIS, the deformation database providing a mapping between a plurality of RIS element deformations and one or more observations expected for each of the plurality of RIS element deformations; and
send, to at least one of the RIS or the network entity, a codebook pattern update to compensate for the RIS element deformation for the at least one RIS element.

2. The apparatus of claim 1, wherein the observation information associated with the plurality of signals comprises at least one of:
one or more in-phase and quadrature (IQ) samples;
one or more reference signal received power (RSRP) measurements; or
one or more phase estimations.

3. The apparatus of claim 1, wherein to send the codebook pattern update, the one or more processors are configured to cause the apparatus to:
determine a set of precoding weights based at least in part on the RIS element deformation for the at least one RIS element of the plurality of RIS elements; and
send, to the at least one of the RIS or the network entity, the set of precoding weights.

4. The apparatus of claim 1, wherein:
to configure the plurality of nodes, the one or more processors are configured to configure the plurality of nodes with the plurality of time-frequency resources for transmitting the plurality of signals to the network entity via the RIS; and
to obtain the observation information, the one or more processors are configured to obtain the observation information from the network entity.

5. The apparatus of claim 1, wherein:
to configure the plurality of nodes, the one or more processors are configured to configure the plurality of nodes with the plurality of time-frequency resources for receiving the plurality of signals from the apparatus or the network entity via the RIS; and
to obtain the observation information, the one or more processors are configured to obtain the observation information from the plurality of nodes.

6. The apparatus of claim 5, wherein the one or more processors are configured to cause the apparatus to send the plurality of signals to the plurality of nodes via the RIS.

7. The apparatus of claim 1, wherein:
to configure the plurality of nodes, the one or more processors are configured to cause the apparatus to configure the plurality of nodes with the plurality of time-frequency resources for transmitting the plurality of signals to the apparatus via the RIS; and
to obtain the observation information, the one or more processors are configured to determine the observation information based on the plurality of signals.

8. The apparatus of claim 1, wherein the one or more processors are configured to cause the apparatus to configure the plurality of nodes with a plurality of signal attributes for communicating the plurality of signals, the plurality of signal attributes comprising at least a plurality of transmit beams or a plurality of receive beams for communicating the plurality of signals.

9. The apparatus of claim 1, wherein the plurality of RIS element deformations included in the deformation database comprise one or more of:
a plurality of RIS element bend types;
a plurality of RIS element bend angles;
a plurality of RIS element tilt types;
a plurality of RIS element tilt angles; or
a plurality of RIS element translations.

10. The apparatus of claim 1, wherein the RIS element deformation determined for the at least one RIS element comprises at least one of:
a location change; or
an orientation change.

11. The apparatus of claim 1, wherein:
the one or more processors are configured to cause the apparatus to receive an indication of a degradation of the RIS; and
to configure the plurality of nodes, the one or more processors are configured to cause the apparatus to configure the plurality of nodes based on receiving the indication.

12. An apparatus configured for wireless communications, comprising:
one or more memories; and
one or more processors coupled to the one or more memories, the one or more processors being configured to cause the apparatus to:
receive a first configuration of a plurality of time-frequency resources for receiving a plurality of signals via a reconfigurable intelligent surface (RIS) comprising a plurality of RIS elements;
receive, via one or more of the plurality of time-frequency resources, one or more signals of the plurality of signals via the RIS;
determine observation information associated with the one or more signals received at the apparatus, wherein the observation information comprises at least one of:
one or more in-phase and quadrature (IQ) samples;
one or more reference signal received power (RSRP) measurements; or
one or more phase estimations; and
send the observation information to a first network entity.

13. The apparatus of claim 12, wherein:
the apparatus comprises a user equipment; and
to receive the one or more signals, the one or more processors are configured to cause the apparatus to receive the one or more signals from the first network entity or a second network entity.

14. The apparatus of claim 12, wherein:
the apparatus comprises a second network entity; and
to receive the one or more signals, the one or more processors are configured to cause the apparatus to receive the one or more signals from one or more user equipments.

15. The apparatus of claim 12, wherein the one or more processors are configured to cause the apparatus to receive a second configuration of a plurality of signal attributes for receiving the plurality of signals, the plurality of signal attributes comprising at least a plurality of receive beams for receiving the plurality of signals.

16. The apparatus of claim 12, wherein the one or more processors are configured to cause the apparatus to obtain at least one of:
a codebook pattern; or
a channel estimate for a channel associated with each of the one or more signals.

17. The apparatus of claim 16, wherein:
to determine the observation information, the one or more processors are configured to cause the apparatus to determine the observation information associated with the one or more signals received at the apparatus based at least in part on the codebook pattern or the channel estimate for the channel associated with each of the one or more signals, and
the observation information comprises the one or more phase estimations.

18. A method of wireless communications by an apparatus, comprising:
configuring a plurality of nodes with a plurality of time-frequency resources for communicating a plurality of signals with the apparatus or a network entity via a reconfigurable intelligent surface (RIS) comprising a plurality of RIS elements;
obtaining observation information associated with the plurality of signals communicated between the plurality of nodes and the apparatus or the network entity via the RIS;
determining an RIS element deformation for at least one RIS element of the plurality of RIS elements based at least in part on the observation information and a deformation database associated with the RIS, the deformation database providing a mapping between a plurality of RIS element deformations and one or more observations expected for each of the plurality of RIS element deformations; and
sending, to at least one of the RIS or the network entity, a codebook pattern update to compensate for the RIS element deformation for the at least one RIS element.

19. The method of claim 18, wherein the observation information associated with the plurality of signals comprises at least one of:
one or more in-phase and quadrature (IQ) samples;
one or more reference signal received power (RSRP) measurements; or
one or more phase estimations.

20. A method of wireless communications by an apparatus, comprising:
receiving a first configuration of a plurality of time-frequency resources for receiving a plurality of signals via a reconfigurable intelligent surface (RIS) comprising a plurality of RIS elements;
receiving, via one or more of the plurality of time-frequency resources, one or more signals of the plurality of signals via the RIS;
determining observation information associated with the one or more signals received at the apparatus, wherein the observation information comprises at least one of:
one or more in-phase and quadrature (IQ) samples;
one or more reference signal received power (RSRP) measurements; or
one or more phase estimations; and
sending the observation information to a first network entity.
